(19) United States
(12) Patent Application Publication
(10) Pub. No.: US 2024/0010790 A1
(43) Pub. Date: Jan. 11, 2024

(54) STABILIZER BASED ON POLYOL PEROXIDE AND PROCESS FOR MAKING POLYMER POLYOLS

(71) Applicants: REPSOL, S.A., Madrid (ES); NOURYON CHEMICALS INTERNATIONAL B.V., Arnhem (NL)

(72) Inventors: Juan Pedro PÉREZ VALENCIA, Madrid (ES); Luis VEGA BERMEJO, Madrid (ES); José Antonio CARAZO ANGULO, Madrid (ES); Estanislao SAN NICOLÁS SAYANS, Madrid (ES); Michel VAN DEN BERG, Deventer (NL); Petrus Wilhelmus Gerardus VAN DER KRUIJS, Deventer (NL); Hendrik Cornelis VAN DASSELAAR, Deventer (NL); Bart FISCHER, Deventer (NL)

(21) Appl. No.: 18/251,559

(22) PCT Filed: Nov. 3, 2021
(86) PCT No.: PCT/EP2021/080516

§ 371 Date: May 3, 2023

(30) Foreign Application Priority Data
Nov. 4, 2020 (EP) 20382957.7

(51) Int. Cl. C08G 65/332; C08F 220/44

(52) U.S. Cl. CPC C08G 65/332; C08F 220/44

(57) ABSTRACT

The present invention refers to macroinitiators of general formula (HO)ₓ—R^{a}—(O—C(═O)—R^{b}—C(═O)—O—O—R^{c})_{y}, a process for obtaining them, as well as their use in the synthesis of polymer polyols. It also relates to the resulting polymer polyol, as well as to a dispersant obtainable in the process for preparing the polymer polyol, said dispersant being obtained by reacting said macroinitiator with at least one ethylenically unsaturated monomer.

### FIELD OF THE INVENTION

The present invention relates to a macroinitiator suitable as stabilizer precursor in the synthesis of polymer polyols, to a process for preparing polymer polyols using said macroinitiator, and to polymer polyols obtainable by this process.

### BACKGROUND

Polymer polyols are high volume commercial products whose main use is the production of polyurethane foams. Polymer polyols contain dispersions of particles of a vinyl polymer in liquid base polyol formed from the in situ polymerization of selected compounds, such as acrylonitrile, styrene, methyl methacrylate and vinyl chloride and mixtures thereof. Commercially, the most important products are based on acrylonitrile and styrene.

The presence of the polymer particles in the polyol imparts various desirable properties to polyurethanes, particularly flexible polyurethane foams prepared from the polyol. In particular, the polymer particles act as a reinforcing filler and cell opener in the foam.

Polymer polyols are prepared by dispersion polymerization which first involves the production of radicals resulting from the thermal decomposition of a free-radical initiator, which in turn reacts with a vinylic monomer to form growing oligoradicals. Depending on its solubility in the medium, each oligoradical collapses into a condensed state when a certain threshold molecular weight is reached, giving rise to primary particles which attract either other primary particles or already existing larger ones.

Typically, azo compounds such as AIBN and AMBN, and peroxides are being used as initiators. Reaction takes place at temperatures within the range 80 to 130° C., monomer being added to polyol at such a rate that its concentration remains low throughout the process. Chain transfer agents are generally used to control molecular weight.

Semi-Batch and continuous processes have been described for the manufacture of polymer polyols and, in both cases, carefully controlled conditions are required to ensure that a stable dispersion with the correct particle size distribution is obtained.

A problem generally found in the manufacture of polymer polyols is to obtain a polymer polyol having both a relatively high solid polymer content and a sufficiently low viscosity for ease of handling. A polymer polyol having this combination of properties is favourable for the properties of any polyurethane foam produced from such polymer polyol.

High level of dispersed polymer particles (a concentrated polymer polyol) provides enhanced reinforcement and cell opening. In addition, the production of high level solids polymer polyols increase productivity since it is possible to get products containing smaller amounts just by diluting the concentrate product.

One problem with concentrated polymer polyol is that the dispersed polymer particles tend to agglomerate and then settle out of the continuous polyol phase invalidating its use. It is therefore desirable to prepare the concentrated polymer polyol in such a way that the tendency of the particles to agglomerate is minimized.

Another problem of concentrated polymer polyol dispersions is the exponential increase in viscosity with polymer particle content which usually hampers polymer particle concentration up to a viscosity limit, since pumping equipment used by foamers generally cannot handle high viscosities at an acceptable rate or with acceptable accuracy.

Furthermore, polymer polyols should not contain very large particles which may cause the foam to be brittle and have poor fatigue properties. Nor should they include small particles that could be detrimental for viscosity and which do not reinforce the foam structure effectively and do not open cells properly.

In order to improve the stability of the polymer polyol dispersions and to avoid the problems mentioned above, stabilizers or dispersants are generally used. Type of stabilizer/dispersant and its concentration, may determine the particle size and particle size distribution which, in addition, affects product viscosity.

The most successful type of stabilizer/dispersant devised for use in dispersion polymerization has been based on a block or graft copolymer which consists of two essential polymeric components, one soluble and one insoluble in the continuous phase. The insoluble component, or anchor group, associates with the disperse phase polymer. It may become physically adsorbed into the polymer particle, or can be designed so that it reacts chemically with the disperse phase after absorption.

The dispersant may be either preformed or formed in situ. In any of these cases, a “precursor” is usually employed. This precursor is also known as “macromonomer” or “macromer”.

Macromers are polyether polyols (identical or different to the liquid base polyol) with terminal double bonds, able to copolymerize with vinylic monomers and to form graft dispersants during the radical copolymerization. The polyol part typically contains long chains that are highly soluble in the continuous phase of the polymer polyol.

The resulting block copolymer after reacting the macromer with vinylic monomers is in fact a non-aqueous dispersant which introduces polyol-soluble moieties onto the copolymer particles leading to improved particle stability.

Most of the state of the art macromonomers are based on 3-isopropenyl-α,α-dimethylbenzyl isocyanate (TMI) adduct of a polyol ether alcohol based on sorbitol propylene oxide and ethylene oxide.

Thus, polymer polyol processes are divided in two depending on graft-dispersant synthesis:
In situ formation simultaneously to polymer polyol synthesis process. In this process, macromer is added to the organic liquid serving as the polymerization medium (liquid base polyol). The monomer system being polymerized will react with the macromer during polymerization to form, in situ, a graft or addition copolymer dispersant. Thus, this process involves the simultaneous dispersion polymerization of monomers to produce polymer particles and block copolymer dispersant formation by grafting reaction of a macromonomer or macromer and monomers [CA2227346, WO99/40144, EP0405608, U.S. Pat. No. 5,093,412, WO99/10407, U.S. Pat. Nos. 4,652,589; 4,454,255; 4,458,038; 4,460,715; 4,119,586; 4,208,314].
Preformed stabilizer synthesis. In this case, the graft copolymer dispersant synthesis takes place apart from the main polymerization process, in a dedicated synthesis. Reaction procedure is similar to polymer polyol synthesis (it uses the same or similar reaction scheme, initiator, chain transfer agent, monomers . . . ) but employing different concentrations, having a concentrated preformed stabilized “solution” which is added directly to polymer polyol reaction process [WO2015/165878, WO2014/137656, WO2012/154393, WO2013/158471, EP193864, U.S. Pat. No. 4,550,194 and WO97/15605].

By the use of macromonomers, particularly TMI-sorbitol polyolether type with functionality <1 (TMI molecules per polyol molecule), the following proposed dispersants formed are:
Diblock linear copolymers: In this case, propagation from the macromer doesn't occur so, one time the chain reaction incorporates the macromer, the polymer dies. Initiation from macromere also leads to diblock linear copolymers. For macromeres with functionality >1, triblock linear and star structures are plausible. Also, these structures can be formed from grafting (H-abstraction) in the polylether chains.
Graft and comb copolymers (lateral polyolether) chains. The macromer propagates as other monomers. Recent laboratory results with high functionality macromers (>1) shows crosslinking, validating propagation reactions.

In the case of semi-batch synthesis with macromers, the formation of the comb copolymer-type dispersant with a high macromer fraction incorporated in each molecule of copolymer is favored. This typically leads to dispersions with a small particle size distribution (narrow) and small particle size that penalizes viscosity. If the process is carried out with addition in semibatch of the macromer, larger particle sizes are obtained but with dispersions that tend towards aggregation, that is, non-stable dispersions.

The continuous processes are favored when the dispersant or stabilizer is pre-formed as a step prior to the reaction leading to the obtaining of the polymeric polyol, which leads to a greater number of reaction steps as a disadvantage.

In view of that, although dispersion stabilizers disclosed in the prior art results in polymer polyols having relatively high polymer contents in combination with relatively low viscosities, there is still room for improvement, particularly in the effectiveness of applying the stabilizer. In this regard, it is desirable to optimise the number of process steps, the way in which the stabilizer is prepared, as well as the number and concentrations of the components necessary to synthesize the dispersant and the polymer polyol, while maintaining an excellent stability performance enabling the manufacture of polymer polyol having high polymer content in combination with a low viscosity.

### BRIEF DESCRIPTION OF THE INVENTION

In accordance with the invention, there is provided an optimised process for preparing a polymer polyol which is based on the use of a compound suitable as stabilizer or dispersant precursor characterized in that it comprises a polyol and a free-radical initiator group in its structure.

This compound allows replacing the macromer generally used as a precursor of the dispersant in the prior art by a compound that combines the soluble polyol function with a group capable of generating free radicals that make it possible to initiate the polymerization reaction of ethylenically unsaturated monomers and the consequent formation of the dispersant.

Therefore, unlike the macromers of prior art, the functionality of the double bond is replaced by the functionality of the free radical initiator so that, once these radicals are generated, they can react with the ethylenically unsaturated monomers forming (co) polymers that also act as dispersants or stabilizers of the polymeric polyol.

This compound has been called “macroinitiator” in the present invention.

By using this macroinitiator, it is not necessary to pre-form the dispersant as a prior and independent process to obtain the polymeric polyol, so that at least one stage in the synthesis thereof is saved.

Furthermore, as demonstrated in the examples provided, the polymeric polyol can be obtained by any of the standard procedures, both semi-batch and continuous, providing in any case stable dispersions that combine an adequate particle size, particle size distribution, viscosity and processability.

The use of the macroinitiator of the present invention favours the formation of block copolymers since the amount of grafted species has been shown to be very small compared to ungrafted styrene-acrylonitrile (SAN) copolymer chains, thus allowing a product with larger particle size (greater than 0.5 microns) and greater stability as compared to the product obtained in the semi-batch process using macromers. Depending on the functionalization (number of initiation points per macroinitiator molecule), diblock, tri or star configurations could be also achieved. Furthermore, as also derivable from the experimental data, the resulting polymer polyol present low thickening values and no hysteresis, which is indicative of stable dispersions.

Therefore, using the macroinitiators of the invention in the semibatch synthesis of polymer polyols allows the provision of products with higher particle size and lower viscosity for a given solids content, that are additionally more stable than conventional polymer polyols obtained using macromers in semibatch.

With respect to the continuous process where a preformed dispersant is mostly used, an advantage derived from the use of the macroinitiator of the invention is the possibility of carrying out the polymerization reaction in the absence of solvent.

In addition, the process for obtaining the polymeric polyol is carried out in a single step (although several reactors may be necessary), obtaining a product of better characteristics with respect to the use of pre-formed macromers, in terms of viscosity and weight proportion of particles (solids) obtained. In addition, the amount of macroinitiator to be added is equal to or even less than the amount of macromer that is needed to pre-form the dispersant.

Thus, a first aspect of the present invention relates to a macroinitiator suitable as stabilizer precursor in a polymer polyol, said macroinitiator having formula (I):

(HO)ₓ—R^{a}—(O—C(═O)—R^{b}—C(═O)—O—O—R^{c})_{y} (I)
where:
R^{a} is a polyether polyol, a polyester polyol or a polycarbonate polyol said polyol having a number average molecular weight of at least 250 Da and at least 2 free hydroxyl groups, wherein the number average molecular weight is measured by size exclusion chromatography using polyethylene glycol as standard;
R^{b} is selected from a linear or branched C₁-C₆ alkanediyl, a linear or branched C₂-C₆ alkenediyl and a C₆-C₁₄ aryldiyl,
   wherein R^{b} is optionally substituted with one or more substituents selected from a linear or branched unsubstituted C₁-C₆ alkyl, a linear or branched unsubstituted C₂-C₆ alkenyl, an unsubstituted C₆-C₁₄ aryl, an unsubstituted C₄-C₁₀ cycloalkyl, an unsubstituted C₄-C₁₀ cycloalkenyl, a C₄-C₁₀ cycloalkenyl substituted with C₁-C₈ alkyl, and C₄-C₁₀ cycloalkyl substituted with C₁-C₈ alkyl group;
R^{c} is selected from a linear or branched C₁-C₈ alkyl and a C₄-C₁₀ to cycloalkyl;
   wherein R^{c} is optionally substituted with one or more substituents selected from a linear or branched unsubstituted C₁-C₈ alkyl, a linear or branched unsubstituted C₂-C₆ alkenyl and an unsubstituted C₆-C₁₄ aryl;
the index “x” is an average value ranging from 1 to 13;
the index “y” is an average value ranging from 0.1 to 2.5.

Another aspect of the present invention relates to a process (also referred to as process 1) for preparing a macroinitiator as defined above, said process comprises the following steps:
a) reacting a cyclic anhydride of formula (III):

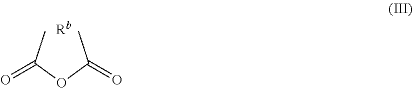

wherein R^{b}is selected from a linear or branched C₁-C₆ alkanediyl, a linear or branched C₂-C₆ alkenediyl and a C₆-C₁₄ aryldiyl,
   wherein R^{b} is optionally substituted with one or more substituents selected from a linear or branched unsubstituted C₁-C₆ alkyl, a linear or branched unsubstituted C₂-C₆ alkenyl, an unsubstituted C₆-C₁₄ aryl, an unsubstituted C₄-C₁₀ cycloalkyl, an unsubstituted C₄-C₁₀ cycloalkenyl, a C₄-C₁₀ cycloalkenyl substituted with C₁-C₈ alkyl, and C₄-C₁₀ cycloalkyl substituted with C₁-C₈ alkyl group;
with an organic hydroperoxide of formula R^{c}OOH,
   wherein R^{c} is selected from a linear or branched C₁-C₈ alkyl and a C₄-C₁₀ cycloalkyl,
      wherein R^{c} is optionally substituted with one or more substituents selected from a linear or branched unsubstituted C₁-C₈ alkyl, a linear or branched unsubstituted C₂-C₆ alkenyl and an unsubstituted C₆-C₁₄ aryl;
to form an acid-peroxyester of formula (II):

HO—C(═O)—R^{b}—C(═O)—O—O—R^{c} (II),
wherein R^{b} and R^{c} are as defined above;
b) forming an activated intermediate by reacting said acid-peroxyester of formula (II) with either:
   (i) an halogenating agent or
   (ii) a haloformate,
c) reacting the activated intermediate with a polyether polyol, a polyester polyol or a polycarbonate polyol, having a number average molecular weight of at least 250 g/mol and at least 2 free hydroxyl groups; wherein the number average molecular weight is measured by size exclusion chromatography using polyethylene glycol as standard.

A further aspect of the present invention refers to a macroinitiator obtainable by the process as defined above.

As stated above, the macroinitiator of the present invention is an excellent stabilizer precursor for polymer dispersions in a liquid polyol medium. Accordingly, an additional aspect of the invention refers to a process (also referred to as process 2) for preparing a polymer polyol, said process comprises free-radical polymerizing in a base polyol at least one ethylenically unsaturated monomer in the presence of a free-radical polymerization initiator, and a macroinitiator as the one described herein before. Optionally, this polymerization reaction is also carried out in the presence of a chain transfer agent (also known as CTA).

A further aspect of the present invention refers to a stabilizer obtainable in situ in the process for preparing the polymer polyol as described above, said stabilizer being obtained by reacting the macroinitiator of formula (I) as defined above with at least one ethylenically unsaturated monomer. The reaction takes place at a temperature which allows the thermal decomposition of the macroinitiator of formula (I), so as the O—O bonds are broken leading to free-radicals.

Finally, the invention also refers to a polymer polyol obtainable by a process as defined above, said polymer polyol comprising 30-60 wt %, based on the total weight of the polymer polyol, of a polymer derived from at least one ethylenically unsaturated monomer, which polymer is dispersed in a base polyol and stabilized with a dispersant as defined above.

### DETAILED DESCRIPTION OF THE INVENTION

In the context of the present invention, by the term “macroinitiator” should be understood a molecule of polyol which is functionalized with peroxide group(s), more preferably with 0.1-2 mol of peroxide groups/mol polyol, and having formula (I) as mentioned above. This molecule acts as precursor in the preparation of the stabilizer in the synthesis of polymer polyols. Particularly, by thermal decomposition, the peroxide group provides two radicals, at least one of these having the polyol part. This radical, by radical polymerization initiation with ethylenically unsaturated monomer(s), propagation and termination or by chain transfer, generates in turn a dispersant-type block copolymer in the medium where polymer polyol is obtained.

In the present disclosure the terms “dispersant” and “stabilizer” are used indistinctly.

As used herein, “C₁-C₆ alkanediyl” should be understood a divalent radical of an optionally substituted (as further defined herein) linear or branched saturated hydrocarbon chain having from 1 to 6 carbon atoms. Examples of alkanediyl groups include methylene (—CH₂—), ethylene (—CH₂—CH₂—), n-propylene (—CH₂—CH₂—CH₂—), i-propylene (—CH₂—CH(CH₃)—), butylene (—CH₂—CH₂—CH₂—CH₂—), etc.

As used herein, “C₂-C₆ alkenediyl” should be understood a divalent radical of an optionally substituted (as further defined herein) linear hydrocarbon chain containing at least one unsaturation (double bond) and having from 2 to 6 carbon atoms. Examples of alkenediyl groups include ethenediyl (—CH═CH—), n-propendiyl (—CH=CH—CH₂—), iso-propendiyl (—CH(CH₃)═CH—), butenediyl (—CH₂—CH=CH—CH₂—; —CH═CH₂—CH₂—CH₂—), etc.

As used herein, “C₆-C₁₄ aryldiyl” refers to a divalent radical of an optionally substituted (as further defined herein) aromatic ring system containing from 6 to 14 carbon atoms. According to an embodiment, aryldiyl can be a phenyldiyl, naphthyldiyl, indenyldiyl, fenanthryldiyl or anthracyldiyl radical, preferably a phenyldiyl.

As used herein, “C₁-C₈ alkyl” refers to an optionally substituted (as further defined herein) linear or branched hydrocarbon chain radical containing carbon and hydrogen atoms, containing no unsaturation, having one to eight carbon atoms, and which is attached to the rest of the molecule by a single bond, e. g., methyl, ethyl, n-propyl, i-propyl, n-butyl, i-butyl, t-butyl, n-pentyl, etc.

As used herein, “C₂-C₆ alkenyl” refers to an unsubstituted linear hydrocarbon chain containing at least one unsaturation (double bond) and having from 2 to 6 carbon atoms. Examples of alkenyl groups include ethenyl (—CH=CH2), n-propenyl (—CH═CH—CH₃), butenediyl (—CH₂—CH═CH—CH₃; —CH═CH₂—CH₂—CH₃), etc.

As used herein, “C₆-C₁₄ aryl” refers to an unsubstituted aromatic ring system containing from 6 to 14 carbon atoms. Examples of aryl are phenyl, naphthyl, indenyl, fenanthryl or anthracyl radical.

As used herein, “C₄-C₁₀ cycloalkyl” refers to an optionally substituted (as further defined herein) stable 4- to 10-membered monocyclic or bicyclic hydrocarbon radical which is saturated or partially saturated, and which has solely carbon atoms in the ring structure. Unless otherwise stated specifically in the specification, the term “cycloalkyl” is meant to include cycloalkyl radicals which are optionally substituted by a C₁-C₈ alkyl group.

As used herein, “C₄-C₁₀ cycloalkenyl” refers to an optionally substituted (as further defined herein) stable 4- to 10-membered monocyclic or bicyclic hydrocarbon group containing at least one unsaturation (double bond) having from 4 to 10 carbon atoms and which consist solely of carbon and hydrogen atoms. Unless otherwise stated specifically in the specification, the term “cycloalkenyl” is meant to include cycloalkenyl radicals which are optionally substituted by a C₁-C₈ alkyl group.

As used herein, the term “polyether polyol” should be understood a hydroxyl-containing polyether having a hydroxyl functionality of at least 1, preferably at least 2, and more preferably at least 3. The functionality of suitable polyether polyols is less than or equal to 8, preferably between 3 and 6. The suitable polyether polyols may also have functionalities ranging between any combination of these upper and lower values, inclusive.

As used herein, the term “polyester polyol” refers to a hydroxyl-containing polyester having a hydroxyl functionality of at least 1, preferably at least 2, and more preferably at least 3. The functionality of suitable polyester polyols is less than or equal to 8, preferably between 3 and 6. The suitable polyester polyols may also have functionalities ranging between any combination of these upper and lower values, inclusive. The polyester structure of the polyol ester thus have functional ester groups within the polymer chain.

As used herein, the term “polycarbonate polyol” refers to a hydroxyl-containing polycarbonate having a hydroxyl functionality of at least 1, preferably at least 2, and more preferably at least 3. The functionality of suitable polycarbonate polyols is less than or equal to 8, preferably between 3 and 6. The suitable polycarbonate polyols may also have functionalities ranging between any combination of these upper and lower values, inclusive. The polycarbonate structure of the polyol carbonate thus have functional carbonate groups within the polymer chain.

As used herein, the term “polymer polyol”, also referred to as dispersed polymer, refers to a composition produced by polymerizing one or more ethylenically unsaturated monomers at least partially dissolved and/or dispersed in a polyol in the presence of a free radical catalyst or initiator and a stabilizer to form a stable dispersion of polymer particles in the polyol. These polymer polyols have the valuable property of imparting to, for example, polyurethane foams and elastomers produced therefrom, higher load-bearing properties than are provided by the corresponding unmodified polyols.

As used herein, the term “ethylenically unsaturated monomer” refers to a monomer containing ethylenic unsaturation (>C═C<, i.e. two double bonded carbon atoms) that is capable to undergoing free radically induced addition polymerization reactions. Examples include styrene, acrylonitrile, alpha-methyl-styrene, methyl methacrylate and the like.

As used herein, the term “macromer” or “macromonomer” refers to a molecule which comprises one or more polymerizable double bonds able to copolymerize with vinylic monomers such as styrene and acrylonitrile and which comprises one or more hydroxyl-terminated polyether chains. Typical macromeres comprise polyether polyols having an unsaturated group, which are commonly manufactured by reacting a standard polyether polyol with an organic compound containing an unsaturated group and a carboxyl, anhydride, isocyanate, epoxy or other functional group able to react with active hydrogen-containing groups. Examples of useful isocyanates comprise TMI (dimethyl meta isopropenyl benzyl isocyanate) and IEM (isocyanato ethyl methylacrylate).

The macroinitiator of the present invention has formula (I) as defined herein above.

In said macroinitiator of formula (I), R^{a} is a polyol selected from a polyether polyol, a polyester polyol and a polycarbonate polyol, the polyol having a number average molecular weight of at least 250 Da and at least 2 free hydroxyl groups. More preferably the polyol is a polyether polyol.

The polyether structure of the polyether polyol is preferably formed by propylene oxide homopolymer, random or blocked propylene oxide-ethylene oxide copolymer with or without ethylene oxide terminal groups.

The hydroxyl number of suitable polyols, such as polyether polyols, is at least about 9, preferably at least about 12, and most preferably at least about 20. Polyols, such as polyether polyols typically have a hydroxyl number of less than or equal to 60, preferably less than or equal to about 55, and most preferably less than or equal to 50. The suitable polyols, such as polyether polyols, may also have a hydroxyl number ranging between any combination of these upper and lower values, inclusive. For example, the polyol may have a hydroxyl number within the range of from 2 to 60.

The molecular weight of said polyol, such as a polyether polyol, is preferably less than 100,000 Da, i.e., the molecular weight is at least 250 Da and less than 100,000 Da. For example, the molecular weight of said polyol, such as a polyether polyol, may be within the range of from 250 to 90,000 Da. More preferably, the molecular weight of said polyol, such as a polyether polyol, ranges from 1,000 to 20,000 Da, even more preferably from 2,000 to 15,000 Da, most preferably from 4,000 to 15,000 Da.

Said molecular weight is the number average molecular weight (Mn). Particularly, said number average molecular weight is measured by size exclusion chromatography (SEC), using polyethylene glycol as standard. The number average molecular weight of the polyethylene glycol used as standard is within the limits of the expected molecular weight of the polyol to be measured.

The weight average molecular weight. (Mw) will be given by equation Mw=Mn·PDI, wherein PDI is the polydispersity index. The weight average molecular weight can also be measured by size exclusion chromatography (SEC), using polyethylene glycol as standard, as in the case of the number average molecular weight.

In a preferred embodiment, the number average molecular weight is similar to the weight average molecular weight (Mw) since the polydispersity is preferably close to 1.

In a preferred embodiment, the weight average molecular weight of the polyol, such as a polyether polyol, is preferably less than 100,000 Da, more preferably from 250 Da to less than 100,000 Da, and even most preferably from 4,000 to 15,000 Da.

The method to measure said molecular weights (both the number average and the weight average) are described for example by van Leuwen et al., Advances in Urethane Science and Technology, volume 2. Eds., K. C. Frisch and S. L. Reegen, Technomic Publishers, Westport, C, USA, 1973, p. 173.

In a preferred embodiment, the polyol, such as a polyether polyol, has a hydroxyl functionality of at least 1, preferably at least 2, and more preferably at least 3. The functionality of suitable polyether polyols preferably ranges from 3 to 8, more preferably between 3 and 6. By the term “hydroxyl functionality” it should be understood the number of hydroxyl groups per molecule of polyol, which is theoretically equal to the number of hydroxyl groups of the initiator molecule used in the polyol synthesis.

It has been found particularly advantageous that the polyol is a polyether polyol and that the polyether polyol has a number average molecular weight between 5,000 and 15,000 Da, a hydroxyl functionality in the range from 3 to 6, and a primary hydroxyl content in the range 0 to 100%, more preferably from 75 to 95%. The polyether polyol can also have a secondary hydroxyl content in the range 0 to 100%, i.e., the polyether polyol can have only primary hydroxyl content or only secondary hydroxyl content or a mixture thereof.

In another preferred embodiment, the average value for index “x” ranges from 2 to 10, more particularly from 3.5 to 5.9 in the case of a hexol, and from 7.5 to 9.9 in the case of a hexol dimer.

In another preferred embodiment, R^{a} is a polyether polyol as defined above and the average value for index “x” ranges from 1 to 13.

In the macroinitiator of formula (I), R^{b} is selected from a linear or branched C₁-C₆ alkanediyl, a linear or branched C₂-C₆ alkenediyl and a C₆-C₁₄ aryldiyl, wherein R_{b} is optionally substituted with one or more substituents selected from a linear or branched unsubstituted C₁-C₆ alkyl, a linear or branched unsubstituted C₂-C₆ alkenyl, an unsubstituted C₆-C₁₄ aryl, an unsubstituted C₄-C₁₀ cycloalkyl, an unsubstituted C₄-C₁₀ cycloalkenyl , a C₄-C₁₀ cycloalkenyl substituted with C₁-C₈ alkyl, and C₄-C₁₀ cycloalkyl substituted with C₁-C₈ alkyl group.

In a preferred embodiment, R^{b} is selected from —CH₂—CH₂—, —CH═CH—, —CH₂—CH₂—CH₂—, —CH═CH—CH₂—, —CH(CH₃)—CH₂—, —CH(CH₃)═CH—, —CH(CH₃)—CH(CH₃)—, —C(CH₃)═C(CH₃)—, and —C₄H₆—.

In the macroinitiator of formula (I), R^{c} is selected from a linear or branched C₁-C₈ alkyl and a C₄-C₁₀ cycloalkyl, wherein R^{c} is optionally substituted with one or more substituents selected from a linear or branched unsubstituted C₁-C₈ alkyl, a linear or branched unsubstituted C₂-C₆ alkenyl and an unsubstituted C₆-C₁₄ aryl.

In a preferred embodiment, R^{c} is selected from tert-butyl, tert-amyl, 1,1,3,3-tetramethylbutyl, pinane and cumyl.

The average number of y, i.e. the average number of hydroxy groups of the polyol that are functionalised with peroxyester groups, is in the range 0.1-2.5, preferably 0.5-2.0, more preferably 0.8-1.5.

In a particular embodiment, part of the hydroxy groups of the polyol should remain unfunctionalised, so that the macroinitiator contains polar hydroxy groups.

In another preferred embodiment, the functionality of the macroinitiator is in the range 0.8 to 2, more preferably from 0.8 to 1.5. The functionality of the macroinitiator should be understood as the moles of radical initiating group per mol of polyol. It is a measure of the number of polyol chains which are functionalized with the radical initiating group. For example, in the case of hexol (which has six polyol chains per molecule) having functionality 1, there is one chain (average) having functionality.

In a more preferred embodiment, the macroinitiator is selected from: MI-1-MI-10:

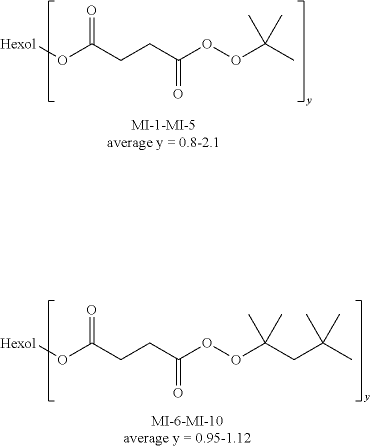

The macroinitiator of formula (I) can be prepared according to the process 1 of the present invention, which comprises the following steps:
a) reacting a cyclic anhydride of formula (III):

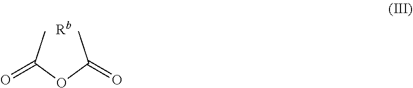

wherein R^{b} is selected from a linear or branched C₁-C₆ alkanediyl, a linear or branched C₂-C₆ alkenediyl and a C₆-C₁₄ aryldiyl,
   wherein is optionally substituted with one or more substituents selected from a linear or branched unsubstituted C₁-C₆ alkyl, a linear or branched unsubstituted C₂-C₆ alkenyl, an unsubstituted C₆-C₁₄ aryl, an unsubstituted C₄-C₁₀ cycloalkyl, an unsubstituted C₄-C₁₀ cycloalkenyl, a C₄-C₁₀ cycloalkenyl substituted with C₁-C₈ alkyl, and C₄-C₁₀ cycloalkyl substituted with C₁-C₈ alkyl group;
with an organic hydroperoxide of formula R^{c}OOH,
wherein R^{c} is selected from a linear or branched C₁-C₈ alkyl and a C₄-C₁₀ cycloalkyl,
   wherein R^{c} is optionally substituted with one or more substituents selected from a linear or branched unsubstituted C₁-C₈ alkyl, a linear or branched unsubstituted C₂-C₆ alkenyl and an unsubstituted C₆-C₁₄ aryl;
      to form an acid-peroxyester of formula (II):

HO—C(═O)—R^{b}—C(═O)—O—O—R^{c} (II),

wherein R^{b}and R^{c} are as defined above
b) forming an activated intermediate by reacting said acid-peroxyester of formula
   (II) with either:
      (i) an halogenating agent or
      (ii) a haloformate,
c) reacting the activated intermediate with a polyether polyol, a polyester polyol or a polycarbonate polyol, having a number average molecular weight of at least 250 g/mol and at least 2 free hydroxyl groups; wherein the number average molecular weight is measured by size exclusion chromatography using polyethylene glycol as standard as described above.

Step a) involves the reaction between the cyclic anhydride of formula (III) and the organic hydroperoxide of formula R^{c}OOH towards an acid-peroxyester.

The cyclic anhydride is preferably selected from the group consisting of succinic anhydride, itaconic anhydride, maleic anhydride, phthalic anhydride, glutaric anhydride, or glutaconic anhydride. These preferred cyclic anhydrides can be optionally substituted with a linear or branched C₂-C₆ alkenyl, a linear or branched C₁-C₆ alkyl, C₆-C₁₄ aryl, C₄-C₁₀ cycloalkyl, or C₄-C₁₀ cycloalkenyl groups as defined above.

Preferred hydroperoxides are tert-butyl hydroperoxide, tert-amyl hydroperoxide, 1,1,3,3-tetramethylbutyl hydroperoxide, pinane hydroperoxide, and cumyl hydroperoxide. More preferred are tert-butyl hydroperoxide, tert-amyl hydroperoxide, 1,1,3,3-tetramethylbutyl hydroperoxide, and cumyl hydroperoxide Even more preferred are 1,1,3,3-tetramethylbutyl hydroperoxide, and cumyl hydroperoxide Most preferred is 1,1,3,3-tetramethylbutyl hydroperoxide, since this hydroperoxide decomposes at relatively low temperature and gives correct particle sizes during polymer polyol formation.

Step a) is performed at 0° C.-75° C., more preferred at 5° C.-50° C., even more preferred at 10° C.-45° C., even more preferred at 20° C.-40° C., most preferred at 30° C.-35° C.

The cyclic anhydride is dissolved in a suitable solvent, such as ethyl benzene, toluene, ethyl acetate or TXIB. Most preferred is ethyl benzene since this product can also be used during the formation of the polymer polyol.

Optionally a catalyst, f.i. sodium acetate, may be added to facilitate this reaction.

The acid-peroxyester resulting from step a) has the formula HO—C(═O)—R^{b}—C(═O)—O—O—R^{c}(II).

In this formula, R^{b} is selected from a linear or branched C₁-C₆ alkanediyl, a linear or branched C₂-C₆ alkenediyl and a C₆-C₁₄ aryldiyl, wherein R_{b}, is optionally substituted with one or more substituents selected from a linear or branched unsubstituted C₁-C₆ alkyl, a linear or branched unsubstituted C₂-C₆ alkenyl, an unsubstituted C₆-C₁₄ aryl, an unsubstituted C₄-C₁₀ cycloalkyl, an unsubstituted C₄-C₁₀ cycloalkenyl, a C₄-C₁₀ cycloalkenyl substituted with C₁-C₈ alkyl, and C₄-C₁₀ cycloalkyl substituted with C₁-C₈ alkyl group. R^{c} is selected from a linear or branched C₁-C₈ alkyl and a C₄-C₁₀ cycloalkyl, wherein R^{c} is optionally substituted with one or more substituents selected from a linear or branched unsubstituted C₁-C₈ alkyl, a linear or branched unsubstituted C₂-C₆ alkenyl and an unsubstituted C₆-C₁₄ aryla linear or branched C₁-C₆ alkyl group or a C₆-C₁₄ aryl group.

R^{b} is preferably selected from —CH₂—CH₂—, —CH═CH—, —CH₂—CH₂—CH₂—, —CH═CH—CH₂——CH(CH₃)—CH₂—, —CH(CH₃)═CH—, —CH(CH₃)—CH(CH₃)—, —C(CH₃)═C(CH₃)—, and -Ph-.

R^{c} is preferably selected from tert-butyl, tert-amyl, 1,1,3,3-tetramethylbutyl, and cumyl.

In step b), the acid-peroxyester resulting from step a) is reacted with either (i) a halogenating agent or (ii) a haloformate to form an activated intermediate.

Reaction with the halogenating agent results in the transformation of the carboxylic acid-group of the acid-peroxyester into an acyl halide group:

X—C(═O)—R^{b}—C(═O)—O——R^{c} (IV)

wherein X is a halogen, preferably Cl or Br, most preferably Cl.

Suitable halogenating agents are COCl₂, (COCl)₂, SOCl₂, POCl₃, PCl₃, PCl₅, POBr₃, and PBr3. SOC12, PC13, COC12 being the most preferred.

Step b (i) is performed at −15° C.-55° C., more preferred at −10° C.-35° C., even more preferred at −5° C.-20° C., most preferred at 0° C.-5° C.

This reaction may be conducted in the presence of a catalyst, preferably a base. Suitable bases for this step are pyridine and dimethyl formamide. Pyridine being the most preferred.

Reaction with a haloformate results in the coupling of the formate group on the carboxylic acid group of the acid-peroxyester.

In a particular embodiment, the haloformate has formula X—C(═O)—O—R^{d} (V), wherein X is a halogen, preferably Cl or Br, most preferably Cl; and wherein R^{d}is selected from linear and branched C₂-C₅ alkyl groups.

The haloformate is preferably selected from the groups consisting of ethylchloroformate, propylchloroformate and isopropylchloroformate. Most preferred is isopropylchloroformate.

When the haloformate of the formula (V) is used, this results in the following activated intermediate:

R^{d}—O—C(═O)—O—C(═O)—R^{b}—C(═O) —O—O—R^{c} (VI)

wherein R^{b}, R^{c} and R^{d} as defined above.

In step b (ii) the acid-peroxyester of formula (II) obtained in step a) is extracted to the aqueous phase using a base. Examples of suitable bases are the oxides, hydroxides, bicarbonates and carbonates of magnesium, lithium, sodium, potassium, or calcium.

Step b (ii) is performed at 0° C.-40° C., more preferred at 10° C.-30° C., most preferred at 15° C.-20° C.

This reaction may be conducted in the presence of a catalyst, preferably a base. Suitable bases are tertiary amines. Preferable bases are 1,4-diazabicyclo[2.2.2]octane (DABCO), 1,4-dimethylpyrazine and N-methyl morpholine. Most preferred is N-methyl morpholine.

The catalyst is added at levels of 0-80%, more preferred 0.5-50%, even more preferred 1-25%, most preferred 2-10%.

Optionally a phase transfer catalyst can be added at levels of 0-40%, more preferred 2-20%, most preferred 5-10%.

Suitable phase transfer catalysts are tertiary ammonium salts like tetrabutylammonium chloride, tetrabutylammonium bromide, tetrabutylammonium iodide and tetrabutylammonium hydrogensulfate. Preferable phase transfer catalysts are tetrabutylammonium chloride and tetrabutylammonium bromide, most preferred tetrabutylammonium bromide.

In step c), the activated intermediate of formula (IV) or (VI) obtained in step b) is reacted with a polyether polyol, a polyester polyol or a polycarbonate polyol such as those defined above.

Step c) is performed at 0° C.-80° C., more preferred at 10° C.-60° C., even more preferred 20° C.-45° C., most preferred at 30° C.-35° C.

This reaction may be conducted in the presence of a catalyst, preferably a base. Suitable bases are tertiary amines. Preferable bases are triethylamine, N,N-diisopropylethylamine, 1,4-diazabicyclo [2.2.2]octane (DABCO), 3-quinuclidinol and N-methyl morpholine. More preferred are triethylamine, 1,4-diazabicyclo [2.2.2]octane (DABCO), 3-quinuclidinol. Even more preferred are 1,4-diazabicyclo[2.2.2]octane (DABCO) and 3-quinuclidinol. Most preferred is 1,4-diazabicyclo [2.2.2]octane (DABCO).

The catalyst is added at levels of 0-80%, more preferred 0.25-50%, even more preferred 0.5-25%, most preferred 1-5%.

Although it would be possible to couple the acid-peroxyester resulting from step a) directly with the polyol in step c) under acidic conditions, this would lead to a significant extent of transesterification, instead of esterification of the polyol. In order to prevent this, the formation of an activated intermediate in step b) is required.

In a preferred embodiment, the activated intermediate of formula (IV) or (VI) is reacted with a polyether polyol.

Such polyether polyol, also frequently referred to as polyoxyalkylene polyols, are typically obtained by reacting a starting compound having a plurality of active hydrogen atoms with one or more alkylene oxides, such as ethylene oxide, propylene oxide, butylene oxide or mixtures of two or more of these. In a preferred embodiment, the compound having a plurality of active hydrogen atoms is a polyol having hydroxyl functionalities ranging from 3 to 8, such as glycerol (having functionality 3) and sorbitol (having functionality 6) and mixtures thereof.

The hydroxyl numbers of suitable polyether polyols is at least about 9, preferably at least about 12, and most preferably at least about 20. Polyether polyols typically have hydroxyl numbers of less than or equal to 60, preferably less than or equal to about 55, and most preferably less than or equal to 50. The suitable polyether polyols may also have hydroxyl numbers ranging between any combination of these upper and lower values, inclusive.

The molecular weight of said polyether polyol is preferably less than 100,000 Da, more preferably from 1,000 to 20,000, even more preferably from 2,000 to 15,000, most preferably from 4,000 to 15,000. Said molecular weight is the number average molecular weight. In a preferred embodiment, the polydispersity index is close to 1 and therefore, the number average molecular weight is similar to the weight average molecular weight.

In a preferred embodiment, the polyether polyol has a hydroxyl functionality of at least 1, preferably at least 2, and more preferably at least 3. The functionality of suitable polyether polyols is less than or equal to 8, preferably between 3 and 6.

It has been found particularly advantageous the use of a polyether polyol having a number average molecular weight between 5,000 and 15,000 Da, a hydroxyl functionality in the range from 3 to 6, and a primary hydroxyl content in the range 0 to 100%, more preferably from 75 to 95%. The polyether polyol can also have a secondary hydroxyl content in the range 0 to 100%, i.e., the polyether polyol can have only primary hydroxyl content or only secondary hydroxyl content or a mixture thereof.

As also mentioned above, other polyols may also be used to prepare the macroinitiator of the invention, such as polyol polyesters or polyol polycarbonates.

As stated above, the macroinitiator of the present invention is an excellent stabilizer precursor for polymer dispersions in a liquid polyol medium. Accordingly, a further aspect of the present invention refers to a process (also referred to as process 2 of the invention) for preparing a polymer polyol, said process comprises free-radical polymerizing in a base polyol at least one ethylenically unsaturated monomer in the presence of a free-radical polymerization initiator and a macroinitiator of formula (I) as the one described herein before. Optionally, the polymerization reaction is also carried out in the presence of a chain transfer agent (also known as CTA).

The base polyol used in the process to prepare the polymer polyol may be any polyol known to be suitable as the liquid medium in polymer polyol systems. Accordingly, any polyol commercially available for polyurethane systems can in principle be used. The base polyol used may be the same polyol as the polyol used for preparing the macroinitiator, but can also be a different polyol.

Preferably, any known polyol having a hydroxyl functionality of at least 2 and less than or equal to 8 can be used as base polyol (A) in the present invention. The functionality of suitable polyols is preferably less than or equal to 6, and preferably from 3 to 5.

In another particular embodiment, the polyol has a hydroxyl number in the range 10 to 400, preferably from 15 to 150, more preferably from 15 to 100, most preferably from 20 to 75.

As used herein, the hydroxyl number is defined as the number of milligrams of potassium hydroxide required for the complete hydrolysis of the fully phthalylated derivative prepared from 1 gram of polyol. The hydroxyl number can also be defined by the equation:

OH=(56.1x1000xf)/Mw
wherein:
OH: represents the hydroxyl number of the polyol
f: represents the functionality of the polyol, i.e. the average number of hydroxyl groups per molecule of polyol, and
Mw: represents the weight average molecular weight of the polyol which can be measured according to the procedure mentioned above.

In a preferred embodiment, the base polyol is a polyether polyol. Examples of suitable polyether polyols include polyoxyethylene glycols, triols, tetrols and higher functionality polyols; polyoxypropylene glycols, triols, tetrols and higher functionality polyols; and mixtures thereof. When ethylene oxide and propylene oxide mixtures are used to produce the polyether polyol, the ethylene oxide and propylene oxide may be added simultaneously or sequentially to provide internal blocks, terminal blocks or a random distribution of oxyethylene groups and/or oxypropylene groups in the polyether poyol. Suitable starters for the base polyol include, for example, ethylene glycol, propylene glycol, diethylene glycol, dipropylene glycol, tripropylene glycol, trimethylol-propane, glycerol, pentaerythritol, sorbitol, sucrose, ethylenediamine and toluene diamine. By alkoxylation of the starter, a suitable polyether polyol useful as the base polyol component can be formed. The alkoxylation reaction may be catalysed using any conventional catalyst including, for example, potassium hydroxide, caesium hydroxide or a double metal cyanide (DMC) catalyst.

Other polyols suitable for use as the base polyol of the present invention include: alkylene oxide adducts of 1,3-dihydroxypropane, 1,3-dihydroxybutane, 1,4-dihydroxybutane, 1,4-, 1,5-, 1,6-dihydroxyhexane, 1,2-, 1,3-, 1,4-, 1,6-, 1,8-dihydroxy octane, 1,10-dihydroxydecane, glycerol, 1,2,4-trihydroxybutane, 1,2,6-trihydroxyhexane, 1,1,1-trimethyl-olethane, 1,1,1-trimethylol propane, pentaerythritol, caprolactone, polycaprolactone, xylitol, arabitol, sorbitol, mannitol and the like.

In a preferred embodiment, the base polyol is a propylene oxide adduct of glycerine containing of about 12 wt % random ethylene oxide with a hydroxyl number of about 55 and a 490 mPa·s viscosity, commercially available under the name Alcupol® F-5511 from Repsol Química.

In another preferred embodiment, the base Polyol is a propylene oxide adduct of glycerine containing of about 19 wt % ethylene oxide cap with hydroxyl number of about 35 and a 835 mPa·s viscosity, commercially available under the name Alcupol® F-3541 from Repsol Química.

Other polyols which can be used as a base polyol include the alkylene oxide adducts of non-reducing sugars, wherein the alkylene oxides have from 2 to 4 carbon atoms. Non-reducing sugars and sugar derivatives include sucrose, alkyl glycosides such as ethylene glycol glycoside, propylene glycol glucoside, glycerol glucoside, and 1,2,6-hexanetriol glucoside, as well as alkylene oxide adducts of the alkyl glycosides.

Other suitable polyols include the polyphenols and preferably alkylene oxides adducts thereof in which the alkylene oxides have from 2 to 4 carbon atoms. Among the suitable polyphenols are bisphenol A, bisphenol F, condensation products of phenol and formaldehyde, the novolac resins, condensation products of various phenolic compounds and acrolein, including the 1,1,3-tris(hydroxyl-phenyl)propanes, condensation products of various phenolic compounds and glyoxal, glutaraldehyde, and other dialdehydes, including the 1,1,2,2-tetrakis(hydroxyphenol)ethanes.

The polyol amount to be used in the process to prepare the polymer polyol is not critical and can be varied within wide limits. Typically, the amount can vary from 35 to 80 wt %, preferably from 45 to 70 wt %, more preferably from 50 to 60 wt %, based on the total weight of the components used to prepare the polymer polyol, i.e., base polyol, ethylenically unsaturated monomer(s), free-radical initiator, macroinitiator and, optionally, chain transfer agent. The particular polyol used will depend on the end use of the polyurethane foam to be produced. A mixture of various useful polyols can be used, if desired.

Suitable ethylenically unsaturated monomers for preparing the dispersed polymer (or polymer polyol) include: aliphatic conjugated dienes such as butadiene and isoprene; monovinylidene aromatic monomers such as styrene, α-methylstyrene, (t-butyl) styrene, chlorostyrene, cyanostyrene and bromostryrene; α,β-ethylenically unsaturated carboxylic acids and esters thereof such as acrylic acid, methacrylic acid, methyl methacrylate, ethyl acrylate, 2-hydroxyethyl acrylate, butyl acrylate, itaconic acid, maleic anhydride and the like; α,β-ethylenically unsaturated nitriles and amides such as acrylonitrile, mathacrylonitrile, acrylamide, methacrylamide, N,N-dimethyl acrylamide, N-(dimethylaminomethyl)acrylamide and the like; vinyl esters such as vinyl acetate; vinyl ethers, vinyl ketones, vinyl and vinylidene halides as well as a wide variety of other ethylenically unsaturated materials which are copolymerizable with the aforementioned monomeric adduct or reactive monomer. It is understood that mixtures of two or more of the above-mentioned monomers may also be employed to make the stabilizer. Monovinylidene aromatic monomers and ethylenically unsaturated nitriles are particularly preferred, even more preferably styrene (SM) and acrylonitrile (AN), resulting in the dispersed polymers styrene-acrylonitrile (SAN) copolymers.

When using a mixture of monomers, it is preferred to use a mixture of two monomers. As mentioned above, most preferable is a mixture of styrene and acrylonitrile. These monomers are typically used in weight ratios of from 88:12 (SM:AN) to 20:80 (SM:AN).

Contrary to other processes of the state of the art wherein high ratios of SM/AN provide non-stable dispersions, the use of macroinitiators in the synthesis of polymer polyols allows the use of SM/AN ratios of up to 6, while maintaining stability and large particle size as pointed out in the examples provided herewith.

The amount of ethylenically unsaturated monomer(s) used may vary between 10 and 60 wt % based on total weight of base polyol, monomer(s) and macroinitiator. Preferably, however, the amount of the ethylenically unsaturated monomer(s) is 20 to 55 wt %, more preferably from 30 to 50 wt %, based on total weight of the components used to prepare the polymer polyol, i.e., base polyol, ethylenically unsaturated monomer(s), free-radical initiator, macroinitiator and, optionally, chain transfer agent.

During the process to prepare the polymer polyol, a stabilizer or dispersant is formed in situ by means of the reaction of the macroinitiator of formula (I) with part of the ethylenically unsaturated monomer(s). The dispersant thus allows the stabilization of the solid particles of the polymer polyol.

Although the macroinitiator mainly acts as free-radical initiator of the reaction that leads to the formation of the dispersant during the formation of the polymer polyol, said macroinitiator may also act as initiator in the polymerization process of the polymer polyol. However, it is preferable the presence of an additional free-radical initiator such as those typically used in these type of polymerization reactions.

Suitable free-radical initiators include peroxides including both alkyl and aryl hydroperoxides, acyl peroxides, peroxyesters, persulfates, perborates, percarbonates and azo compounds. Some specific examples include hydrogen peroxide, dibenzoyl peroxide, didecanoyl peroxide, lauroyl peroxide, t-butyl hydroperoxide, benzoyl peroxide, di-t-butyl peroxide, di(3,5,5-trimethylhexanoyl)peroxide, t-butylperoxy diethyl acetate, t-butyl peroctoate, t-butyl peroxy isobutyrate, t-butyl peroxy 3,5,5-trimethyl hexanoate, t-butyl perbenzoate, t-butyl peroxy pivalate, t-butyl peroxy-2-ethyl hexanoate, tert-amyl peroxy-2-ethylhexanoate, (1,1,3,3-tetramethylbutyl peroxy-2-ethylhexanoate), cumene hydroperoxide, azobis(isobutyronitrile) (AIBN) and 2,2′-azo bis-(2-methylbutyronitrile) (AMBN).

Among the useful initiators, preferably are those having a satisfactory half-life within the temperature ranges used in the polymerization reaction, i.e., the half-life should be about 25% or less of the residence time in the reactor at any given time. Preferred initiators include acyl peroxides such as didecanoyl peroxide, lauroyl peroxide and di(3,5,5-trimethylhexanoyl)peroxide, peroxyesters such as tert-amyl peroxy-2-ethylhexanoate, (1,1,3,3-tetramethylbutyl peroxy-2-ethylhexanoate), and azo compounds such as azobis(isobutyronitrile) (AIBN) and 2,2′-azo bis-(2-methylbutyronitrile) (AMBN).

Even more preferably is the use of di(3,5,5-trimethylhexanoyl)peroxide (herein referred as to Trigonox-36), tert-amyl peroxy-2-ethylhexanoate (herein referred as to Trigonox 121) or (1,1,3,3-tetramethylbutyl peroxy-2-ethylhexanoate) (herein referred as to Trigonox 421) having, respectively, the following chemical formula:

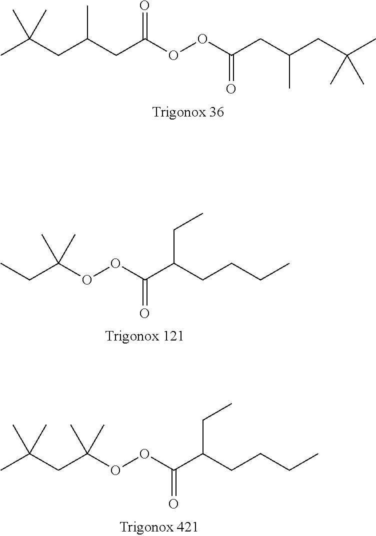

Since the macroinitiator also takes part in the polymerization reaction leading to the polymer polyol, lower amounts of additional free-radical initiator than those amounts generally used in the prior art may be added. Thus, in a particular embodiment, the free-radical initiator is usually applied in an amount from 0.01 to 2 wt %, preferably from 0.05 to 1 wt %, based on the total weight of the components (i.e., base polyol, ethylenically unsaturated monomer(s), macroinitiator, free-radical polymerization initiator and, optionally the chain transfer agent). Increases in initiator concentration result in increases in monomer conversion up to a certain point, but past this, further increases do not result in substantial increases in conversion.

Chain transfer agents may also be added to or be present in the polymerization reaction medium in small amounts. The use of chain transfer agents and their nature is known in the art. They are also commonly referred to as molecular weight regulators since they are employed to control the molecular weight of the copolymer. If used at all, the chain transfer agent is suitable used in an amount of from 0.1 to 6 wt %, preferably from 0.2 to 2 wt %, based on the total weight of reactants. Suitable chain transfers agents for use in the practice of the present invention include isopropanol, ethanol, tert-butanol, methanol, toluene, ethylbenzene, trimethylamine, water, cyclohexane, terpinolene, mercaptans such as dodecanethiol, ethanethiol, 1-heptanethiol, 2-octanethiol and toluenethiol. In a preferred embodiment, the chain transfer agent is terpinolene.

As mentioned above, during the free-radical polymerization that leads to the formation of the polymer polyol, a dispersant is formed in situ when the macroinitiator used initially generates polyol radicals which react with part of the ethylenically unsaturated monomer(s) in the presence of the other components of the formulation. Therefore, contrary to other processes described in the prior art, based on macromer copolymerization reactions, there is no need to obtain a pre-formed dispersant or stabilizer but the dispersant is formed in the reaction medium, thus avoiding additional steps in the process to obtain the polymer polyol.

Therefore, one of the advantages of the process to produce a polymer polyol according to the present invention is that it does not involve a separate polymerization step to obtain an isolated dispersant or stabilizer. Instead, a dispersant precursor (i.e., the macroinitiator) is used and the dispersant is formed in the same reactor along with the formation of the dispersed polymer (polymer polyol) when the macroinitiator reacts with the monomers building this polymer.

Accordingly, a further aspect of the present invention relates to a dispersant obtainable in situ in the process for preparing the polymer polyol, said dispersant being obtained by reacting the macroinitiator of formula (I) as defined above with at least one ethylenically unsaturated monomer.

In a particular embodiment, the temperature in which the reaction takes place should be selected to allow the thermal decomposition of the macroinitiator of formula (I), so as the O—O bonds are broken leading to free-radicals that enable initiating the polymerization of the ethylenically unsaturated monomer(s).

The various components used in the process to prepare polymer polyols in accordance with the present invention may be mixed together in different ways. This can be achieved batchwise or in a continuous operation.

In a particular embodiment, the process is achieved semibatchwise, in which some of the base polyol (10 to 90 wt % with respect to the total weight of base polyol) is charged into a reactor, particularly under a nitrogen atmosphere and heated to the required reaction temperature. The remaining ingredients, i.e., the ethylenically unsaturated monomer(s), the free-radical polymerization initiator, the macroinitiator, the chain transfer agent (when used) and the remainder of the base polyol (10 to 90 wt %) are mixed separately and fed into the reactor at a given rate. Each of the components to be fed to the reactor or mixtures thereof can be added separately and mixed in-line obtaining the same result. Polymerization is continued after completion of monomer(s) addition at a given temperature, equal or different to the previous step. Then, volatiles are removed, for example under vacuum using nitrogen as stripping gas for a given time and temperature. Finally, the reactor is allowed to cool, yielding a polymer polyol product.

As an alternative to the process mentioned above, the macroinitiator can be gradually dosed to the reactor. Another alternative is to add part of the macroinitiator (5-15 wt % over total macroinitiator) in the reactor together with part of the base polyol before the monomer(s) addition.

In another particular embodiment, the process to produce the polymer polyol is achieved in a continuous operation. In this particular case, all the raw materials are quantitatively mixed with each other and continuously fed into a continuously stirred tank reactor (CSTR), in which the reaction mixture resides for a given time at a given pressure and temperature, and then is transferred to a degassing process. Alternatively, the polymer polyol is prepared in a two-stage reactor system wherein all the reactants are continuously introduced and the product is withdrawn proportionately through an overflow. More particularly, the two-stage reactor consists of a first stage, continuously stirred tank reactor where feed streams are introduced. The reactor is normally operated liquid full, and the temperature controlled. The outlet from the first stage is fed to a second stage reactor. Pressure of the two stages reactor system can be controlled at a desired value by means of a back pressure control valve placed in the second stage reactor outlet stream. The ethylenically unsaturated monomer(s), the macroinitiator, the free-radical initiator, the base polyol and chain transfer agent (when used), are combined into a single stream and fed at the desired rate to a first stage inlet.

Alternatively, a fraction of the initiator and macroinitiator can also de fed to the second reactor stage, mixing it in line with the output product of the first reactor stage.

The polymerization temperature may be in the range 80-150° C., preferably from 100 to 130° C. In this regard, the macroinitiator, the free-radical initiator and the temperature should be selected so that the macroinitiator and the free-radical initiator have a reasonable rate of decomposition with respect to the hold-up time in the reactor for a continuous flow reactor or the feed time for a semi-batch reactor.

In polymer polyol production, the amount of macroinitiator is selected to obtain the desired solids content, polymer polyol viscosity, mean particle size and filterability as in conventional polymer polyol preparation. However, it has been found that in the process of the invention to prepare polymer polyol the amount of macroinitiator used may be less than the amount of macromers used in conventional processes, while maintaining or significantly improving polymer polyol viscosity, particle size and filterability.

In this regard, the amount of macroinitiator generally ranges from 2 to 5 wt %, based on the total weight feed. As one skilled in the art knows, various factors including the free-radical initiator, the solids content, the weight ratio of ethylenically monomers and process conditions will affect the optimum amount of macroinitiator.

The resultant polymer polyols obtainable by process 2 of the invention exhibit a good combination of properties, in particular an adequate particle size, particle size distribution, high solids content while low viscosity, make them very suitable for its processability in the synthesis of polyurethane foams.

Accordingly, a further aspect of the present invention relates to a polymer polyol obtainable by process 2 as defined above, said polymer polyol comprising up to 60 wt %, based on the total weight of the polymer polyol, of a polymer derived from at least one ethylenically unsaturated monomer, which polymer is dispersed in a base polyol and stabilized with a dispersant as defined above. More preferably, said polymer polyol comprising 30-60 wt %, based on the total weight of the polymer polyol, of a polymer derived from at least one ethylenically unsaturated monomer, which polymer is dispersed in a base polyol and stabilized with a dispersant as defined above.

In a particular embodiment, the polymer polyol exhibit high solids content, i.e., from 30 to 50 wt %, based on the total weight of the resultant polymer polyol, understanding as solids a polymer derived from at least one ethylenically unsaturated monomer which is dispersed in a base polyol. It is preferred that the solid contents of the polymer polyols ranges from 35 to 55 wt % based on the total weight of the polymer polyol.

In another particular embodiment, the polymer polyol of the invention exhibit low viscosities, i.e., less than 25,000 cp, preferably less than 8,000 cp, thus possessing good filterability.

In another particular embodiment, the polymer polyol obtainable by the process 2 of the invention has a relative viscosity lower than 20, preferably less than 17, more preferably between 8 and 9.8. By “relative viscosity” it is understood the ratio between viscosity of the polymer polyol and the viscosity of the base polyol. The viscosity is determined following EN ISO 3219 guidelines, employing a Haake iQ viscotester using the spindle CC25DIN/Ti. Viscosity determination according to this standard is performed at 25° C. and 25 s⁻¹.

In another particular embodiment, the polymer polyol obtainable by the process 2 of the invention exhibit a particle size Dx(50) higher than 0.5 μm, preferably higher than 0.5 μm and lower than 5 μm, preferably higher than 0.5 and lower than 2 μm. The particle size Dx(50) means that 50% volume of the particles present a particle size within said ranges.

Furthermore, the polymer polyol also exhibits multimodal particle size distribution, a property also desirable for this type of polymers. In a particular embodiment, the span of said particle distribution ranges from 2 to 5 μm, preferably from 3 to 4 μm.

Having a wide particle size distribution within a proper particle size limits is critical to polymer polyol performance, both for its viscous flow behavior and for the mechanical performance of foams prepared with the same. Wide particle size distributions leads to high particle packing factors and low surface areas, getting a low viscosity product. As mentioned above, very small particles increase foam load bearing but do not open cells efficiently, whereas very large particles can cause the foam to be brittle and have poor fatigue properties.

In another particular embodiment, the polymer derived from at least one ethylenically unsaturated monomer is a polymer derived from styrene and acrylonitrile monomers.

Furthermore, the use of the macroinitiators of the present invention allows the production of polymer polyols having a high weight ratio of styrene and acrylonitrile monomers. Increasing the content of styrene monomer reduces the scorching in the production of polyurethane foams, cheapens costs and even provides more white foams.

Accordingly, in a particular embodiment, the polymer polyol obtainable by process 2 comprises up to 60 wt %, based on the total weight of the polymer polyol, of a polymer derived from styrene (SM) and acrylonitrile (ACN) monomers in a weight ratio SM:ACN 3-6:1, which polymer is dispersed in a base polyol and stabilized with a dispersant as defined above. More preferably, the polymer polyol obtainable by process 2 comprises 30-60 wt %, based on the total weight of the polymer polyol, of a polymer derived from styrene (SM) and acrylonitrile (ACN) monomers in a weight ratio SM:ACN 3-6:1, which polymer is dispersed in a base polyol and stabilized with a dispersant as defined above.

The polymer polyols of the present invention are particularly useful for the production of polyurethanes, preferably polyurethane foams, which are prepared by reacting said polymer polyol with isocyanates in the presence of polyurethane catalysts, a foaming agent and a cross-linking agent, in accordance with techniques and processes widely known to those skilled in the art.

### EXAMPLES

The following components were used in the examples:
Polyol A: a propylene oxide adduct of sorbitol containing of about 16 wt % ethylene oxide cap with hydroxyl number of about 28. It is commercially available under the name Alcupol F-6011 from Repsol.
Polyol B: a propylene oxide adduct of glycerine containing of about 16 wt % ethylene oxide cap with hydroxyl number of about 35.
Base Polyol A: a propylene oxide adduct of glycerine containing of about 12 wt % random ethylene oxide with a hydroxyl number of about 55 and a viscosity of 490 mPa·s. It is commercially available under the name Alcupol® F-5511 from Repsol Química.
Base Polyol B: a propylene oxide adduct of glycerine containing of about 19 wt % ethylene oxide cap with hydroxyl number of about 35 and a viscosity of 835 mPa·s. It is commercially available under the name Alcupol® F-3541 from Repsol Química.
CTA A: terpinolene, a chain transfer agent
CTA B: 2-propanol, a chain transfer agent
SM: Styrene Monomer
ACN: Acrylonitrile Monomer
TMI: Isopropenyl dimethyl benzyl isocyanate sold as TMI® (META) by Allnex.
Trigonox 36: di(3,5,5-trimethylhexanoyl)peroxide
Trigonox 121: tert-amyl peroxy-2-ethylhexanoate
Trigonox 421: 1,1,3,3-tetramethylbutyl peroxy-2-ethylhexanoate
TBPH: tert-butyl hydroperoxide
TMBH: tetramethylbutyl hydroperoxide
Macromer A: a propylene oxide adduct of sorbitol containing 16 wt % ethylene oxide cap with hydroxyl number of 29 (polyol). This macromer is prepared by reacting, under heating at 90° C., the polyol with 1.2 moles of Isopropenyl dimethyl benzyl isocyanate (sold as TMI® (META) by Allnex) per mole of polyol in the presence of 300 ppmw of tin(II) 2-ethylhexanoate as catalyst for 3 hours under nitrogen atmosphere, resulting in a molecule containing polymerizable carbon-carbon double bonds.
Macromer B: same as Macromer A but containing 1.0 moles of TMI per mol of polyol resulting in a molecule containing polymerizable carbon-carbon double bonds.
Macromer C: it was prepared by heating a propylene oxide adduct of glycerine containing 13 wt % ethylene oxide cap with hydroxyl number of 35 (polyol) with 1.6 parts by weight of maleic anhydride per part of polyol and 0.01 parts by weight of calcium (II) 2-ethylhexanoate catalyst per part of polyol at 145° C. for about 1 hour in a nitrogen atmosphere obtaining and intermediate product. This intermediate product was subsequently reacted with 0.06 parts by weight of propylene oxide per part of polyol at 145° C. for 4 hours. Volatiles were stripped off at 110° C. under vacuum using nitrogen as stripping gas, resulting in a molecule containing 0.75 polymerizable carbon-carbon double bonds per mole of polyol.

### General Procedures to Prepare Macroinitiators (MI)

Preparation of a dry solution of TBHP in ethylbenzene:

A reactor was charged with TBHP-70%, ethylbenzene and NaCl. The mixture was stirred for 10 min at 20° C. before layer separation. The organic phase was dried over MgSO₄ and filtered resulting in a TBHP in ethylbenzene solution. The assay was determined by active oxygen analysis.

### A: Synthesis Using Succinyl Chloride

A reactor was charged with succinyl chloride and a solvent under a nitrogen atmosphere at 5° C. A mixture of a dry TBHP solution in ethylbenzene, pyridine and a solvent was dosed. After dosing the mixture was stirred for 2 h at 20° C. and used as such.

A reactor was charged with a polyol and pyridine under a nitrogen atmosphere. The obtained mixture described above was dosed followed by a post reaction. The reaction mixture was either concentrated in vacuo or filtered using a pressure filter.

B: Synthesis Using Thionyl chloride

### 1: TBHP-Based MI

A round bottom flask was charged with a dry TBHP-solution in ethylbenzene, succinic anhydride and sodium acetate. The mixture was stirred for 2 h at 40° C. before cooling down o 20° C. The residual succinic anhydride was removed by filtration and the tert-butyl monoperoxysuccinate (TBPS) solution was used as such.

A round bottom flask was charged with ethylbenzene and a TBPS-solution in ethylbenzene. After cooling the solution to 8° C. thionyl chloride was added. The mixture was cooled to 2° C. before pyridine was added. After dosing the mixture was stirred for 3 h at 20° C. before being purged with nitrogen to remove excess thionyl chloride.

A reactor was charged with a polyol and the obtained mixture described above was dosed followed by a post reaction.

### 2: TMBH-Based MI

A round bottom flask was charged with ethylbenzene, succinic anhydride and sodium acetate. The mixture was stirred and heated to 35° C. before TMBH-95% was added. After dosing the mixture was stirred for 5 h at 35° C. before cooling down to 20° C. The obtained tetramethylbutyl monoperoxysuccinate (TMBPS) solution was used as such.

A round bottom flask was charged with ethylbenzene and a TMBPS-solution in ethylbenzene. After cooling the solution to 8° C. thionyl chloride was added. The mixture was cooled to 2° C. before pyridine was added. After dosing the mixture was stirred for 3 h at 20° C. or 0° C. before being purged with nitrogen to remove excess thionyl chloride.

A reactor was charged with a polyol and the obtained mixture described above was dosed followed by a post reaction.

### C: Synthesis Using Isopropyl Chloroformate

A reactor was charged with sodium bicarbonate, water and ethylbenzene. A TMBPS-solution in ethylbenzene was dosed. Tetrabutylammonium bromide and N-methylmorpholine were added and after the addition of isopropyl chloroformate the mixture was stirred for 2 h at 20° C. After separation the organic fraction was dried over magnesium sulfate, filtered and used as such.

A reactor was charged with a polyol and pyridine under a nitrogen atmosphere. The obtained mixture described above was dosed followed by the addition of a base. The mixture was stirred at 35° C. and used as such in the polymer polyol synthesis.

### Example 1. Synthesis of Macroinitiators (MI)

### Example 1a. Synthesis of MI-1

A reactor was charged with 33.2 g (258 mmol) TBHP-70%, 10.3 g ethylbenzene and 2.2 g NaCl. The mixture was stirred for 10 min at 20° C. before layer separation. The organic phase was dried over MgSO₄ and filtered resulting in 29 g of a clear TBHP-63.9% solution in ethylbenzene.

A reactor was charged with 8.6 g (55.5 mmol) succinyl chloride and 25 g dichloromethane under a nitrogen atmosphere at 5° C. A mixture of 7.83 g (55.5 mmol) TBHP-63.9% solution in ethylbenzene, 5.0 g (63.2 mmol) pyridine and 15 g dichloromethane was dosed in 15 min. After dosing the mixture was stirred for 2 h at 20° C. and used as such.

A reactor was charged with 500 g (41.7 mmol) Polyol A, 5.0 g (63.2 mmol) pyridine and 200 ml dichloromethane under a nitrogen atmosphere at 10° C. The obtained mixture described above was dosed in 2.5 h at 10° C. followed by a post reaction of 3 h at 25° C. The reaction mixture was concentrated in vacuo yielding 508.6 g of MI-1 (0.80 equiv/mol) as a slightly hazy very viscous oil.

### Example 1b. Synthesis of MI-2

A reactor was charged with 51.60 g (333 mmol) succinyl chloride and 60 g ethylbenzene under a nitrogen atmosphere at 5° C. A mixture of 51.40 g (333 mmol) TBHP-58.3% solution in ethylbenzene, 30.0 g (379 mmol) pyridine and 17.2 g ethylbenzene was dosed in 1 h. After dosing the mixture was stirred for 2 h at 20° C. After filtration to remove the white precipitate 151.4 g of a clear light brown solution was obtained.

A reactor was charged with 660 g (55.0 mmol) Polyol A and 5.8 g (73 mmol) pyridine under a nitrogen atmosphere at 35° C. Part of the obtained mixture described above (40.5 g) was dosed in 1.5 h at 35° C. followed by a post reaction of 2 hat 35° C. The reaction mixture was filtered using a Seitz T500 pressure filter at 4 bar to remove the precipitate formed. After filtration 605.3 g of MI-2 (1.20 equiv/mol) was obtained as a clear very viscous oil.

Example 1c. Synthesis of MI-3

A reactor was charged with 18.9 g (122 mmol) succinyl chloride and 26.5 g ethylbenzene under a nitrogen atmosphere at 5° C. A mixture of 18.50 g (120 mmol) TBHP-58.3% solution in ethylbenzene, 9.6 g (121 mmol) pyridine and 8 g ethylbenzene was dosed in 1 h. After dosing the mixture was stirred for 2 h at 20° C. After filtration to remove the white precipitate 66.9 g of a clear solution was obtained.

A reactor was charged with 543 g (45.3 mmol) Polyol A and 5.8 g (73 mmol) pyridine under a nitrogen atmosphere at 35° C. The obtained mixture described above was dosed in 1.5 h at 35° C. followed by a post reaction of 2 h at 35° C. The reaction mixture was filtered using a Seitz T500 pressure filter at 5-6 bar to remove the precipitate formed. After filtration 528.4 g of MI-3 (2.10 equiv/mol) was obtained as a clear very viscous oil.

### Example 1d. Synthesis of MI-4

A round bottom flask was charged with 114.2 g (887 mmol) TBHP-70%, 38.8 g ethylbenzene and 8.8 g NaCl. The mixture was stirred for 15 min at 20° C. before layer separation. The organic phase was dried over MgSO4 and filtered resulting in 119.5 g of a clear TBHP-64.4% solution in ethylbenzene.

A round bottom flask was charged with 35.92 g (257 mmol) TBHP-64.4% solution in ethylbenzene, 40.2 g ethylbenzene, 28.26 g (282 mmol) succinic anhydride and 1.05 g (12.8 mmol) sodium acetate. The mixture was stirred for 2 hat 40° C. before cooling down to 20° C. The residual succinic anhydride was removed by filtration yielding 103.1 g of a tert-butyl monoperoxysuccinate (TBPS-45%) solution in ethylbenzene which was used as such.

A round bottom flask was charged with 29.7 g ethylbenzene and 36.9 g (87.3 mmol) of a TBPS-45% solution in ethylbenzene. After cooling the solution to 8° C. 14.04 g (118 mmol) thionyl chloride was added. The mixture was cooled to 2° C. before 1.43 g (18.1 mmol) pyridine was added in 10 min. After dosing the mixture was stirred for 3 h at 20° C. before being purged with nitrogen to remove excess thionyl chloride.

A reactor was charged with 1000 g (83.3 mmol) Polyol A at room temperature. The obtained mixture described above was dosed in 1 h and the resulting mixture was stirred for 24 h at room temperature resulting in 1059 g of MI-4 (0.88 equiv/mol) as a slightly hazy dark brown viscous oil.

### Example 1e. Synthesis of MI-5

A round bottom flask was charged with 44.55 g ethylbenzene and 55.34 g (131 mmol) of a TBPS-45% solution in ethylbenzene. After cooling the solution to 8° C. 21.07 g (177 mmol) thionyl chloride was added. The mixture was cooled to 2° C. before 2.14 g (27.1 mmol) pyridine was added in 10 min. After dosing the mixture was stirred for 3 h at 20° C. before being purged with nitrogen for 1 h to remove excess thionyl chloride.

A reactor was charged with 1000 g (83.3 mmol) Polyol A at room temperature. The obtained mixture described above was dosed in 1 h and the resulting mixture was stirred for 24 h at room temperature resulting in 1101 g of MI-5 (1.40 equiv/mol) as a slightly hazy dark brown viscous oil.

### Example 1f. Synthesis of MI-6

A round bottom flask was charged with 129.1 g ethylbenzene, 48.99 g (490 mmol) succinic anhydride and 2.01 g (24.5 mmol) sodium acetate. The mixture was stirred and heated to 35° C. before 82.49 g (515 mmol) TMBH-95% was added in 30 min. After dosing the mixture was stirred for 5 h at 35° C. before cooling down to 20° C. The obtained tetramethylbutyl monoperoxysuccinate (TMBPS-43.3%) solution in ethylbenzene was used as such.

A round bottom flask was charged with 45.9 g ethylbenzene and 105.0 g (184.6 mmol) of a TMBPS-43.3% solution in ethylbenzene. After cooling the solution to 8° C. 11.38 g (95.6 mmol) thionyl chloride was added. The mixture was cooled to 2° C. before 1.12 g (14.17 mmol) pyridine was added in 10 min. After dosing the mixture was stirred for 3 h at 20° C. before being purged with nitrogen for 1 h to remove excess thionyl chloride.

A reactor was charged with 1000 g (83.3 mmol) Polyol A at room temperature. The obtained mixture described above was dosed in 1 h and the resulting mixture was stirred for 24 h at room temperature resulting in 1124 g of MI-6 (1.12 equiv/mol) as a slightly hazy dark brown viscous oil.

### Example 1g. Synthesis of MI-7

A round bottom flask was charged with 13.9 g ethylbenzene and 31.95 g (40.2 mmol) of a TMBPS-31% solution in ethylbenzene. After cooling the solution to 8° C. 6.51 g (54.7 mmol) thionyl chloride was added. The mixture was cooled to 1° C. before 0.65 g (8.22 mmol) pyridine was added in 10 min. After dosing the mixture was stirred for 3 h at 0° C. before being purged with nitrogen for 30 min to remove excess thionyl chloride.

A reactor was charged with 388 g (32.3 mmol) Polyol A at room temperature. The obtained mixture described above was dosed in 15 min and the resulting mixture was stirred for 24 h at room temperature resulting in 430.3 g of MI-7 (0.96 equiv/mol) as a slightly hazy dark brown viscous oil.

### Example 1h. Synthesis of MI-8

In a round bottom flask 3.39 g (40.0 mmol) sodium bicarbonate was dissolved in 50.8 g water. To this solution 29.1 g ethylbenzene was added followed by the slow addition of 21.67 g (40.5 mmol) of a TMBPS-46% solution in ethylbenzene maintaining the mixture at 20° C. To this mixture 1.29 g (4.0 mmol) tertrabutylammonium bromide and 0.41 g (4.1 mmol) N-methylmorpholine were added. After the addition of 4.91 g (40.1 mmol) isopropyl chloroformate maintaining 20° C. the resulting mixture was stirred for 2 h at 20° C. After separation the organic fraction was dried over magnesium sulfate, filtered and used as such.

A reactor was charged with 478 g (39.8 mmol) Polyol A at room temperature. The obtained mixture described above was dosed followed by the addition of 3.98 g (39.3 mmol) triethylamine. The mixture was stirred for 5 h at 35° C. resulting in 524.4 g of MI-8 (0.97 equiv/mol) as a as a slightly hazy colorless viscous oil.

### Example 1i. Synthesis of MI-9

In a round bottom flask 6.89 g (65.0 mmol) sodium bicarbonate was dissolved in 82.3 g water. To this solution 47.3 g ethylbenzene was added followed by the slow addition of 35.12 g (65.6 mmol) of a TMBPS-46% solution in ethylbenzene maintaining the mixture at 20° C. To this mixture 2.10 g (6.5 mmol) tertrabutylammonium bromide and 0.66 g (6.5 mmol) N-methylmorpholine were added. After the addition of 7.98 g (65.1 mmol) isopropyl chloroformate maintaining 20° C. the resulting mixture was stirred for 2 h at 20° C. After separation the organic fraction was dried over magnesium sulfate, filtered and used as such.

A reactor was charged with 750 g (62.5 mmol) Polyol A and 0.35 g (3.12 mmol) 1,4-diazabicyclo[2.2.2]octane (DABCO) at room temperature. The obtained mixture described above was dosed in 25 min and after heating to 35° C. stirring continued for another 30 min resulting in 820.4 g of MI-9 (1.00 equiv/mol) as a slightly hazy colorless viscous oil.

### Example 1J. Synthesis of MI-10

In a round bottom flask 26.50 g (250.0 mmol) sodium bicarbonate was dissolved in 316.5 g water. To this solution 182 g ethylbenzene was added followed by the slow addition of 134.8 g (251.7 mmol) of a TMBP S-46% solution in ethylbenzene maintaining the mixture at 20° C. To this mixture 8.06 g (25.0 mmol) tertrabutylammonium bromide and 2.53 g (25.0 mmol) N-methylmorpholine were added. After the addition of 30.66 g (250.2 mmol) isopropyl chloroformate maintaining 20° C. the resulting mixture was stirred for 2 h at 20° C. After separation the organic fraction was dried over magnesium sulfate, filtered and used as such.

A reactor was charged with 2998 g (249.8 mmol) Polyol A and 1.35 g (12.03 mmol) 1,4-diazabicyclo[2.2.2]octane (DABCO) at room temperature. The obtained mixture described above was dosed in 45 min and after heating to 35° C. stirring continued for 1 h resulting in 3297 g of MI-10 (0.95 equiv/mol) as a slightly hazy colorless viscous oil.

### General Procedures to Prepare Polymer Polyol

Polyols of the present invention have been prepared both semibatchwise or in a continuous operation.

For comparative purposes, polymer polyols have also been prepared by both procedures but using macromers or pre-formed stabilizer instead of macroinitiators.

### Semibatch Polymer Polyol Synthesis

In a two-liter autoclave reactor, part of the base polyol (polyether polyol) is loaded, the reactor is closed, purged with nitrogen and left to slight overpressure under nitrogen atmosphere (+0.8 barg), and heated under stirring to the reaction temperature. Then, a solution composed of monomers, free-radical initiator, macroinitiator, chain transfer agent and the rest of the base polyol (vinyl solution), is fed at room temperature and at a determined flow rate. During the reaction, the feed rate and the reaction temperature are controlled to the set values. Polymerization is continued for 30 minutes after completion of monomer(s) addition at the same reaction temperature. Then, volatiles are removed under vacuum using nitrogen as stripping gas for 2 hours and 130° C. Once the stripping of the reaction product has been finished, it is cooled and discharged from the reactor for further analysis.

In some cases, the addition of the macroinitiator is made gradually by dosing it in the vinyl solution or in two vinyl solutions with different macroinitiator concentrations, feeding the first one and the second one consecutively.

When macromers are used, the procedure is the same but the macromer is initially added to the base polyol, prior to the semibatch feed of the vinyl solution (which in this case contains only the monomers, free-radical initiator, chain transfer agent and the rest of base polyol).

In Examples 2-4 below the procedure for polymer polyol preparation is semibatch.

### Continuous Polymer Polyol Operation

The polymer polyols were prepared in two 300 cc reactors connected in series, provided with stirrers and with temperature, flow and pressure control (backpressure control valve at the outlet of the second reactor). The second reactor is connected to the first one in series. A pre-mixed solution of reactants was pumped continuously into the first reactor in series. A second pre-mixed solution of reactants (initiator, solvent, macromer, preformed stabilizer, chain transfer agent) can optionally also be pumped at a controlled rate using a syringe pump with cooled container into the second reactor together with the first reactor product, according to the test. Once stationary state has been reached, reaction output product is collected from the second reactor in a stirred tank with a thermal jacket for heating and connection to a vacuum system, to perform flash and stripping of the final product of the reaction, in order to remove volatiles.

In examples 6-8 below the procedure for polymer polyol preparation is continuous.

### A. Synthesis Using Macroinitiators.

The procedure is carried out by mixing the different components (base polyol, macroinitiator, monomers, initiator and chain transfer agent), said mixture is continuously fed to the first reactor from a refrigerated tank at 10° C., at a flow determined by the residence time fixed in the first reactor. The output product of the first reactor is fed to the second reactor. Both reactors are thermostated at the temperature set for the reaction and, the pressure is controlled (4 barg) with the valve in the output line of the second reactor (backpressure controller).

The product is recovered in the flash tank, which is subsequently stripped with nitrogen under vacuum and temperature (130° C.) to remove volatiles. The product is cooled and collected for further analysis.

In some cases, the initiator, macroinitiator, CTA and/or base polyol can also be optionally fed to the second reactor, mixing it in line with the output product of the first reactor.

### B. Synthesis Using Macromers.

The same synthesis procedure is used as for the continuous synthesis with macroinitators, substituting the macroinitiator by the macromer.

C. Synthesis using Preformed Stabilizers (PFS).

### Preformed Stabilizer (PFS) Preparation:

Preformed stabilizer is made in a 300 cc continuous stirred tank reactor provided with stirrers and with temperature, flow and pressure control (backpressure control valve at the outlet), from the following raw materials:

TABLE I
Preformed Stabilizer preparation

| Ingredient | Parts by Weight |
|---|---|
| Macromer A | 24 |
| CTA B | 61.78 |
| SM | 7 |
| ACN | 7 |
| Initiator, Trigonox 121 | 0.22 |

The raw materials mixture at 10° C. is pumped to the reactor at a corresponding flow with a 60 minutes residence time in the Reactor. Reaction is performed at a temperature of 120° C. and 3 barg of pressure. The resulting product, i.e. the preformed stabilizer, is cooled and collected once steady state conditions are reached.

### Polymer Polyol Preparation Using a Preformed Stabilizer.

The same synthesis procedure is used as for continuous synthesis with macroinitiators, replacing the macroinitiator with the prepared preformed stabilizer and without adding chain transfer agent, since this component (CTA—B, 2—propanol) is fed with the preformed stabilizer.

The macroinitiators (MI) used in the different processes described in the following examples have a decomposition temperature within the range of 100-140° C., thus being adequate to be used in the polymerization reaction which is carried out at 120° C.

Styrene polymer content of the polymer polyol was determined by means of H-NMR (Bruker AV500, USA), in deuterated acetone.

Acrylonitrile polymer content of the polymer polyol was determined by means of Nitrogen Kjeldhal analysis.

Solids content of the polymer polyol is calculated by adding Styrene and acrylonitrile polymer values.

Dynamic viscosity is determined following EN ISO 3219 guidelines, employing a Haake iQ viscotester using the spindle CC25DIN/Ti. Viscosity determination according to this standard is performed at 25° C. and 25 s⁻¹.

Particle size is determined by static laser diffraction using a Mastersizer 3000 equipment dispersing the sample in ethanol and calculating the particle size distribution using Fraunhofer theory. In the examples, Dx(50) of the product particles is reported, this value corresponds to the median diameter (50% volume of the particles present a particle size below the value of Dx(50)).

Flow Stability is determined by steady state viscous flow measurements at 23° C. using a controlled-stress rheometer (Haake Mars III) at 23° C. using a plate and plate (smooth) geometry (55 mm diameter and 0.5 mm gap) in the range 0.0001-150 s⁻¹ starting from 0.0001 s−1, increasing shear rate progressively up to 150s−1 and decreasing shear rate progressively to 0.0001s−1 again, thus performing a cycle. From this analysis, it is reported the thickening value. The thickening value is obtained by adjusting the shear-thickening regime values to the following equation,

μ=k·γⁿ

where, n is the thickening value, k, a flow consistency index, μ is the viscosity of the product in centi poises at 23° C. measured at the corresponding shear rate, γ, in seconds⁻¹.

Hysteresis phenomena happens when the increasing shear rate viscosity curve does not match the decreasing shear rate viscosity curve.

A lower thickening value in the polymer polyol characterization means better dispersed stabilized product against flow induced particle aggregation, as it is described in the reference: Polymer Testing 50 (2016) 164-171. No hysteresis phenomena means also no particle aggregates are initially present in the product, neither generated nor destroyed by flow induced shear.

### Example 2. Synthesis of Polymer Polyols Using Macroinitiators Using a Semibatch Procedure

A series of semibatch experiments were carried out following the general procedure mentioned herein above, i.e., by charging initially a reactor with base polyol and subsequent feeding of a solution containing monomers (ACN and SM), macroinitiator, free-radical initiator, chain transfer agent and the rest of base polyol.

In some cases (runs 3 to 6), the addition of the vinyl solution is made gradually by dosing it in two semibatch feed solutions with different concentrations, feeding the first one and the second one consecutively. In runs 7 and 8, the second semibatch feed contains also part of the macroinitiator.

Table III shows the components, amounts and conditions used to prepare the polymer polyol according to these procedures. In all the experiments shown in this table, the base polyol, chain transfer agent and free radical initiator are the same (polyol B, CTA—A and Trigonox—36, respectively). In Table IV, the characterization parameters of the obtained polymer polyols using different macroinitiators are shown.

TABLE III
Reaction conditions (% wt is referred to the total amount of product)

| Run | 1 | 2 | 3 | 4 | 5 | 6 | 7 | 8 |
|---|---|---|---|---|---|---|---|---|
| Macroinitiator | MI-1 | MI-1 | MI-1 | MI-1 | MI-2 | MI-6 | MI-7 | MI-7 |
| type | | | | | | | | |
| Temperature | 135 | 135 | 135 | 135 | 135 | 130 | 125 | 125 |
| (° C.) | | | | | | | | |

Batch

| | | | | | | | | |
|---|---|---|---|---|---|---|---|---|
| Polyol B(% wt) | 46.6 | 46.6 | 46.6 | 46.6 | 46.6 | 46.6 | 45.0 | 45.0 |

Semibatch feed 1

| | | | | | | | | |
|---|---|---|---|---|---|---|---|---|
| Macroinitiator | 3 | 3 | 3 | 2.4 | 3 | 2.5 | 1.875 | 1.875 |
| (% wt) | | | | | | | | |
| ACN (% wt) | 14.2 | 14.2 | 9.5 | 9.5 | 10.8 | 9.5 | 7.0 | 2.8 |
| SM (% wt) | 28.4 | 28.4 | 18.9 | 18.9 | 21.6 | 18.9 | 12.6 | 16.7 |
| Polyol B (% wt) | 6.7 | 6.7 | 4.5 | 5.1 | 6.5 | 4.4 | 3.6 | 3.6 |
| CTA-A (% wt) | 0.5 | 0.5 | 0.3 | 0.3 | 1.0 | 0.8 | 0.3 | 0.3 |
| Trigonox 36 | 0.60 | 0.60 | 0.40 | 0.40 | 0.48 | 0.45 | 0.24 | 0.24 |
| (% wt) | | | | | | | | |
| Feed time (min) | 120 | 90 | 80 | 80 | 72 | 100 | 70 | 70 |

Semibatch feed 2

| | | | | | | | | |
|---|---|---|---|---|---|---|---|---|
| Macroinitiator | — | — | 0 | 0 | 0 | 0 | 0.625 | 0.625 |
| (% wt) | | | | | | | | |
| ACN (% wt) | — | — | 4.7 | 4.7 | 2.2 | 4.7 | 8.5 | 3.4 |
| SM (% wt) | — | — | 9.5 | 9.5 | 4.3 | 9.5 | 15.3 | 20.5 |
| Polyol B (% wt) | — | — | 2.2 | 2.2 | 3.3 | 2.0 | 4.4 | 4.4 |
| CTA-A (% wt) | — | — | 0.2 | 0.2 | 0.2 | 0.4 | 0.3 | 0.3 |
| Trigonox 36 | — | — | 0.20 | 0.20 | 0.10 | 0.15 | 0.29 | 0.29 |
| (% wt) | | | | | | | | |
| Feed time (min) | — | — | 40 | 40 | 18 | 50 | 80 | 80 |

TABLE IV
Product characterization

| Run | 1 | 2 | 3 | 4 | 5 | 6 | 7 | 8 |
|---|---|---|---|---|---|---|---|---|
| Viscosity (cp) | 6012 | 5997 | 5924 | 5779 | 5927 | 4348 | 6946 | 8205 |
| Solids (% wt) | 38.6 | 39.1 | 38.9 | 38.9 | 33.3 | 29.8 | 38.8 | 39.4 |
| thickening | 0.061 | 0.070 | 0.068 | 0.064 | 0.042 | 0.036 | 0.047 | 0.053 |
| Hysteresys | no | no | no | no | no | no | no | no |
| Dx (50) microns | 0.70 | 0.72 | 0.64 | 0.71 | 0.46 | 1.67 | 0.69 | 1.36 |

From Table III, it can be seen that all the polymer polyol samples obtained using semibatch addition of macroinitiator give rise to products with a Dx (50) particle size in the range of 0.45-1.7 micrometers, high solids content and low viscosity values. These products present low thickening values and no hysteresis, which indicate stable dispersions. These good results are also obtained in reactions with high SM/ACN copolymerization ratio, as shown in Run 8 and will be discussed later in Example 4.

### Example 3 (Comparative). Synthesis of Polymer Polyols Using Macromers Using a Semibatch Procedure

A series of semibatch experiments have been done, in which macromer is added to the reactor vessel along with part of the base polyol following the procedure mentioned above; this procedure allows obtaining conventional polymer polyols using macromers in semibatch mode. The reaction conditions and components are shown in Table V, where it can be seen that different macromer types and free-radical initiators were used in these reactions.

For comparative purposes, Run 13 was carried out using the same procedure as for Example 2, substituting macroinitiator by macromer in the semibatch feed.

In Table VI, the characterization parameters of the obtained polymer polyols using macromers are shown.

TABLE V
Reaction conditions (% wt is referred to the total amount of product)

| Run | 9 | 10 | 11 | 12 | 13 |
|---|---|---|---|---|---|
| Temperature (° C.) | 125 | 125 | 130 | 140 | 125 |

Batch

| | | | | | |
|---|---|---|---|---|---|
| Polyol B (% wt) | 44.5 | 45.8 | 44.3 | 44.3 | 33 |
| Macromer type | A | A | A | B | C |
| Macromer (% wt) | 2.1 | 0.9 | 2.3 | 2.3 | 0 |

Semibatch feed

| | | | | | |
|---|---|---|---|---|---|
| ACN (% wt) | 14 | 14 | 14 | 14 | 2.9 |
| SM (% wt) | 28 | 28 | 28 | 28 | 13 |
| Polyol B (% wt) | 9.8 | 9.8 | 9.2 | 9.6 | 34 |
| CTA-A (% wt) | 1.3 | 1.3 | 0.9 | 0.5 | 16 |
| Initiator type | Trigonox 121 | Trigonox 121 | Trigonox 36 | Trigonox 121 | Trigonox 421 |
| Initiator (% wt) | 0.32 | 0.32 | 0.65 | 0.65 | 0.67 |
| Feed time (min) | 90 | 90 | 115 | 120 | 180 |

TABLE VI
Product characterization

| Run | 9 | 10 | 11 | 12 | 13 |
|---|---|---|---|---|---|
| Viscosity | 6489 | 7169 | 6073 | 5188 | 25106 |
| (cp) | | | | | |
| Solids | 39.4 | 38.3 | 39.8 | 38.7 | 45.4 |
| (% wt) | | | | | |
| thickening | 0.061 | 0.116 | 0.058 | 0.066 | 0.372 |
| Hysteresys | no | no | no | no | yes |
| Dx (50) | 0.26 | 0.39 | 0.31 | 0.32 | 0.66 |
| microns | | | | | |

Polymer polyols obtained using conventional semibatch process with macromers (runs 9-12) show adequate solid contents and viscosities. But comparing the results of Table V and Table III, higher particle size and lower thickening values are observed for the products obtained using the macroinitiator process. Therefore, using the macroinitiators of the invention in the semibatch synthesis of polymer polyols allows the obtention of products with higher particle size and lower viscosity for a given solids content, that are additionally more stable than conventional polymer polyols obtained using macromers in semibatch.

Run 13, carried out with a different procedure as indicated above, shows that it is not possible to use the macromer following the same synthesis procedure used for the process employing macroinitiators. In this case, despite a high solids content can be obtained together with a higher particle size compared to a conventional process showed in runs 9 to 12, the product is extremely viscous and not stable, presenting hysteresis and a high thickening value. This is indicative of a low quality product, in which the particles of the dispersion will tend to agglomerate.

### Example 4 (Comparative). Synthesis of Polymer Polyols in a Semibatch Procedure Using Higher SM/ACN Copolymerization Ratio

An additional comparative experiment using macromers (Run 14) was done following the procedure of Runs 9-12 above, but using a higher SM/ACN copolymerization ratio in the polymerization reaction. The experimental conditions are shown in Table VII, together with the experimental conditions of Run 8 (experiment using macroinitiators according to the invention). The characterization parameters of the products obtained using a high SM/ACN copolymerization ratio are shown in Table VIII.

TABLE VII
Reaction conditions (% wt is referred
to the total amount of product)

| Run | 14 | 8 |
|---|---|---|
| Temperature (° C.) | 125 | 125 |

Batch

| | | |
|---|---|---|
| Polyol B (% wt) | 43.8 | 45.0 |
| Macromer type | C | — |
| Macromer (% wt) | 2.8 | 0 |

Semibatch feed

| | | |
|---|---|---|
| Macroinitiator type | — | MI - 7 |
| Macroinitiator (% wt) | 0 | 1.875 |
| ACN (% wt) | 4 | 2.8 |
| SM (% wt) | 31 | 16.7 |
| Polyol B (% wt) | 17.4 | 3.6 |
| CTA-A (% wt) | 0.4 | 0.3 |
| Initiator type | Trigonox 421 | Trigonox 36 |
| Initiator (% wt) | 0.52 | 0.24 |
| Feed time (min) | 110 | 70 |

TABLE VIII
Product characterization

| Run | 14 | 8 |
|---|---|---|
| Viscosity (cp) | 9972 | 8205 |
| Solids (% wt) | 33.0 | 39.4 |
| thickening | 0.260 | 0.053 |
| Hysteresys | yes | no |
| Dx (50) microns | 0.78 | 1.36 |

From Table VIII it can be seen that it is possible to obtain stable, low viscosity and high solids content polymer polyols with a high styrene content relative to acrylonitrile, using the new macroinitiators of the invention. Products obtained using macromers under high SM/ACN copolymerization ratio are unstable and lower quality dispersions are obtained.

### Example 5. Mixtures of Conventional Polymer Polyols and Polymer Polyols Obtained Using Macroinitiators

Since it is possible to obtain high particle size and low viscosity products using the macroinitiators of the invention, the mixture of such polymer polyols with lower particle sized products yields polymer polyols with -high solids content and lower viscosity, as shown in the mixtures presented in Table IX. Such a result is a consequence of having different particles sizes, because the smaller particles fit into the gaps between the bigger ones, increasing the packing fraction of the product [Rheology series, 3. An introduction to Rheology. Chapter 7. H. A. Barnes, J. F. Hutton and K. Walters. Elsevier, 1989; Farris, R. J., Trans. Soc. Rheol. 12:281, 1968; Mechanical Packing of spherical particles. R. K. McGeary. Journal of the American Ceramic Society. Vol 44, No. 10, 513-522, 1961].

The mixtures in this Example were obtained by mechanical mixing at ambient temperature of the polymer polyol obtained in Run 8 (according to the invention), which presented a viscosity of 8205 cP, a solids content of 39.4% and a particle size Dx (50) of 1.36 microns, and a conventional polymer polyol obtained using macromers with a much lower particle size (Run 11, with viscosity of 6073 cP, solids content of 39.8% and a particle size Dx (50) of 0.31 microns).

TABLE IX
Properties of mixtures of polymer polyols

| Mixture | A | B | C |
|---|---|---|---|
| Weight ratio of | 1:1 | 2:1 | 1:3 |
| polymer polyols in | | | |
| the mixture | | | |
| (Run 8:Run 11) | | | |

Properties of each mixture

| | | | |
|---|---|---|---|
| Viscosity (cp) | 5164 | 5540 | 5471 |
| Solids (% wt) | 39.5 | 39.4 | 39.6 |
| Dx (50) microns | 0.506 | 0.929 | 0.381 |

It is known that the combination of high and low particle sized products reduces the viscosity of the mixture; therefore the polymer polyols of the invention can be used for this purpose.

### Example 6. Synthesis of Polymer Polyols Using Macroinitiators Using a Continuous Operation

A series of experiments were done following the general procedure for continuous synthesis of polymer polyols mentioned above. In these experiments, different base polyols, free radical initiators, macroinitiators and chain transfer agents were used, as shown in Table X, where also amounts and reaction conditions are indicated. In some of the experiments, the free- radical initiator was added to the two reactors connected in series (Run 17). In other experiments, both free radical initiator and macroinitiator were added to the two reactors connected in series (Runs 18-22). In one experiment, macroinitiator was used in the presence of macromer (Run 23). Table XI presents the characterization parameters of the products obtained.

TABLE X
Reaction conditions (% wt is referred to the total amount of feed)

| Run | 15 | 16 | 17 | 18 | 19 | 20 | 21 | 22 | 23 |
|---|---|---|---|---|---|---|---|---|---|
| Macroinitiator | MI-6 | MI-4 | MI-10 | MI-4 | MI-7 | MI-9 | MI-7 | MI-7 | MI-10 |
| type | | | | | | | | | |
| Macromer type | — | — | — | — | — | — | — | — | C |
| Base polyol type | A | A | A | A | A | A | A | B | A |
| Initiator type | Trigonox | Trigonox | Trigonox | Trigonox | Trigonox | Trigonox | Trigonox | Trigonox | Trigonox |
| | 421 | 36 | 36 | 36 | 36 | 36 | 421 | 36 | 36 |
| CTA type | A | B | A | A | A | A | A | A | A |
| Temperature (° C.) | 125 | 130 | 120 | 130 | 135 | 125 | 125 | 120 | 125 |
| Residence time | 62 | 62 | 60 | 62 | 62 | 45 | 62 | 47 | 47 |
| per reactor (min) | | | | | | | | | |

First reactor feed (% wt)

| | | | | | | | | | |
|---|---|---|---|---|---|---|---|---|---|
| Base Polyol | 44.14 | 40.3 | 43.92 | 43.40 | 44.02 | 37.08 | 44.16 | 44.02 | 44.35 |
| Macroinitiator | 3.8 | 4.5 | 4.29 | 3.75 | 3.98 | 2.29 | 3.99 | 3.98 | 2.00 |
| Macromer | 0 | 0 | 0 | 0 | 0 | 0 | 0 | 0 | 3.00 |
| SM | 34 | 32 | 33.94 | 33.55 | 33.86 | 38.84 | 33.88 | 33.86 | 32.30 |
| ACN | 17 | 16 | 16.97 | 16.78 | 16.93 | 20.44 | 16.94 | 16.93 | 17.00 |
| CTA | 0.8 | 7 | 0.30 | 0.79 | 0.40 | 0.60 | 0.40 | 0.40 | 0.80 |
| Initiator | 0.26 | 0.2 | 0.40 | 0.41 | 0.40 | 0.46 | 0.28 | 0.40 | 0.55 |

Second reactor feed (% wt)

| | | | | | | | | | |
|---|---|---|---|---|---|---|---|---|---|
| Macroinitiator | 0 | 0 | 0 | 1.10 | 0.20 | 0.10 | 0.20 | 0.20 | 0 |
| CTA | 0 | 0 | 0 | 0 | 0 | 0 | 0 | 0 | 0 |
| Initiator | 0 | 0 | 0.19 | 0.22 | 0.20 | 0.19 | 0.16 | 0.20 | 0 |

TABLE XI
Product characterization

| Run | 15 | 16 | 17 | 18 | 19 | 20 | 21 | 22 | 23 |
|---|---|---|---|---|---|---|---|---|---|
| Viscosity (cp) | 3840 | 7178 | 12480 | 5886 | 6059 | 41112 | 10059 | 13810 | 5590 |
| Solids (% wt) | 42.2 | 47.4 | 50.2 | 45.1 | 49.3 | 59.2 | 48.9 | 49.9 | 45.8 |
| thickening | 0.0304 | 0.0575 | 0.113 | 0.043 | 0.0771 | 0.26 | 0.1235 | 0.1069 | 0.0519 |
| Hysteresys | no | no | — | no | no | yes | no | no | no |
| Dx (50) microns | 1.54 | 1.38 | 1.64 | 1.23 | 1.72 | 1.83 | 1.54 | 1.49 | 1.00 |

The above results show that it is possible to obtain high particle-sized and stable polymer polyol dispersions showing adequate viscosity values, using a macroinitiator of the invention in a continuous synthesis process. The resulting products are comparable to those obtained by conventional continuous processes for polymer polyol synthesis, using macromers (in-situ) or preformed stabilizers for stabilizing the polymer dispersion (both in Example 7).

### Example 7. (Comparative) Synthesis of Polymer Polyols Using Macromers or Preformed Stabilizers in a Continuous Operation

A series of continuous polymer polyol synthesis runs using macromers as indicated above in part B for continuous polymer polyol operation or a preformed stabilizer (PFS) obtained as described above in part C for continuous polymer polyol operation were done under the conditions set in Table XII. In the experiment carried out with PFS (Run 29), the isopropanol fed with the preformed stabilizer solution acts as a chain transfer agent (CTA), and no additional CTA was fed. The characterization of the obtained products is shown in Table XIII.

TABLE XII
Reaction conditions (% wt is referred to the total amount of feed)

| Run | 24 | 25 | 26 | 27 | 28 | 29 |
|---|---|---|---|---|---|---|
| Macromer | C | C | C | C | C | — |
| type | | | | | | |
| PFS | — | — | — | — | — | PFS (*) |
| Base polyol | B | A | A | A | A | A |
| type | | | | | | |
| Initiator | Trigonox 36 | Trigonox 421 | Trigonox 36 | Trigonox 36 | Trigonox 36 | Trigonox 36 |
| type | | | | | | |
| CTA type | A | A | A | A | B | — |
| Temperature | 125 | 125 | 125 | 117 | 120 | 120 |
| (° C.) | | | | | | |
| Residence | 35 | 35 | 31 | 43 | 60 | 47 |
| time per | | | | | | |
| reactor | | | | | | |
| (min) | | | | | | |

First reactor feed (% wt)

| | | | | | | |
|---|---|---|---|---|---|---|
| Base Polyol | 52.7 | 47.35 | 46 | 46.39 | 37.12 | 33.58 |
| Macromer | 4.7 | 3.4 | 4.48 | 3.12 | 3.65 | 0 |
| | | | | | | 9.9 |
| SM | 27.4 | 32 | 31.88 | 32.07 | 33.05 | 36 |
| ACN | 13.7 | 16 | 15.94 | 16.03 | 18.36 | 20 |
| CTA | 0.8 | 0.85 | 0.6 | 0.57 | 6.12 | 0 |
| Initiator | 0.7 | 0.4 | 0.7 | 0.62 | 0.41 | 0.52 |

Second reactor feed (% wt)

| | | | | | | |
|---|---|---|---|---|---|---|
| Macromer | 0 | 0 | 0 | 0.8 | 0.19 | 0 |
| CTA | 0 | 0 | 0 | 0 | 0.91 | 0 |
| Initiator | 0 | 0 | 0.39 | 0.4 | 0.18 | 0 |

(*) PFS synthesis described in Table I

TABLE XIII
Product characterization

| Run | 24 | 25 | 26 | 27 | 28 | 29 |
|---|---|---|---|---|---|---|
| Viscosity (cp) | 5080 | 7418 | 6124 | 6364 | 22140 | 11980 |
| Solids (% wt) | 36.2 | 46.7 | 45.8 | 48.5 | 55 | 57.1 |
| thickening | 0.0314 | 0.0888 | 0.0584 | 0.0708 | 0.1 | 0.139 |
| Hysteresys | no | no | no | no | — | no |
| Dx (50) microns | 0.818 | 1.02 | 0.981 | 1.2 | 1.31 | 0.891 |

1. Macroinitiator having the formula (I):
(HO)ₓ—R^{a}—(O—C(═O)—R^{b}—C(═O)—O—O—R^{c})_{y} (I)
wherein:
R^{a} is a polyol selected from a polyether polyol, a polyester polyol and a polycarbonate polyol, said polyol having a number average molecular weight of at least 250 Da and at least 2 free hydroxyl groups; wherein the number average molecular weight is measured by size exclusion chromatography using polyethylene glycol as standard;
R^{b} is selected from a linear or branched C₁-C₆ alkanediyl, a linear or branched C₂-C₆ alkenediyl and a C₆-C₁₄ aryldiyl,
wherein R_{b} is optionally substituted with one or more substituents selected from a linear or branched unsubstituted C₁-C₆ alkyl, a linear or branched unsubstituted C₂-C₆ alkenyl, an unsubstituted C₆-C₁₄ aryl, an unsubstituted C₄-C₁₀ cycloalkyl, an unsubstituted C₄-C₁₀ cycloalkenyl, a C₄-C₁₀ cycloalkenyl substituted with C₁-C₈ alkyl, and C₄-C₁₀ cycloalkyl substituted with C₄-C₈ alkyl group;
R^{c} is selected from a linear or branched C₁-C₈ alkyl and a C₄-C₁₀, cycloalkyl;
wherein R^{c} is optionally substituted with one or more substituents selected from a linear or branched unsubstituted C₁-C₈ alkyl, a linear or branched unsubstituted C₂-C₆ alkenyl and an unsubstituted C₆-C₁₄ aryl;
the index “x” is an average value ranging from 1 to 13; and
the index “y” is an average value ranging from 0.1 to 2.5.

2. The macroinitiator according to claim 1, wherein R^{b} is selected from —CH₂—CH₂—, —CH═CH—, —CH₂—CH₂—CH₂—, —CH═CH—CH₂— —CH(CH₃)—CH₂—, —CH(CH₃)═CH—, —CH(CH₃)—CH(CH₃)—, —C(CH₃)═C(CH₃)—, and —C₆H₄—.

3. The macroinitiator according to claim 1, wherein R^{c} is selected from tert-butyl, tert-amyl, 1,1,3,3-tetramethylbutyl, pinane and cumyl.

4. A process for the preparation of a macroinitiator as defined in claim 1, said process comprising the following steps:
a) reacting a cyclic anhydride of formula (III): 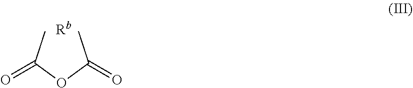
wherein R^{b} is selected from a linear or branched C₁-C₆ alkanediyl, a C₂-C₆ alkenediyl and a C₆-C₁₄ aryldiyl,
wherein R_{b} is optionally substituted with one or more substituents selected from a linear or branched unsubstituted C₁-C₆ alkyl, a linear or branched unsubstituted C₂-C₆ alkenyl, an unsubstituted C₆-C₁₀ aryl, an unsubstituted C₄-C₁₀ cycloalkyl, an unsubstituted C₄-C₁₀ cycloalkenyl, a C₄-C₁₀ to cycloalkenyl substituted with C₁-C₈ alkyl, and C₄-C₁₀ cycloalkyl substituted with C₁-C₈ alkyl group,
with an organic hydroperoxide of formula R^{c}OOH, wherein R^{c} is selected from a linear or branched C₁-C₈ alkyl group, a linear or branched unsubstituted C₂-C₆ alkenyl and a C₄-C₁₀ cycloalkyl, wherein R^{c} is optionally substituted with one or more substituents selected from a linear or branched unsubstituted C₁-C₈ alkyl and an unsubstituted C₆-C₁₄ aryl;
to form an acid-peroxyester of formula (II):
HO—C(═O)—R^{b}—C(═O)—O—O—R^{c} (II),
wherein R^{b} and R^{c} are as defined above;
b) forming an activated intermediate by reacting said acid-peroxyester of formula (II) with either:
(i) a halogenating agent; or
(ii) a haloformate,
c) reacting the activated intermediate with a polyether polyol, a polyester polyol or a polycarbonate polyol, having a number average molecular weight of at least 250 Da and at least 2 free hydroxyl groups; wherein the number average molecular weight is measured by size exclusion chromatography using polyethylene glycol as standard.

5. The process according to claim 4, wherein the cyclic anhydride of formula (III) is succinic anhydride, itaconic anhydride, maleic anhydride, phthalic anhydride, glutaric anhydride, or glutaconic anhydride, optionally substituted with one or more substituents selected from a linear or branched unsubstituted C₁-C₆ alkenyl, a linear or branched unsubstituted C₁-C₆ alkyl, an unsubstituted C₆-C₁₀ aryl, an unsubstituted C₄-C₁₀ cycloalkyl, and an unsubstituted C₄-C₁₀ cycloalkenyl.

6. The process according to claim 4, wherein the organic hydroperoxide is selected from the groups consisting of tert-butyl hydroperoxide, tert-amyl hydroperoxide, 1,1,3,3-tetramethylbutyl hydroperoxide, and cumyl hydroperoxide.

7. The process according to claim 4, wherein the haloformate has the formula X—C(═O)—O—R^{d}, wherein R^{d} a linear or branched unsubstituted C₂-C₅ alkyl and X is a halogen.

8. A process for preparing a polymer polyol, said process comprises free-radical polymerizing in a base polyol at least one ethylenically unsaturated monomer in the presence of a free-radical polymerization initiator, a macroinitiator as defined in claim 1, and optionally a chain transfer agent.

9. The process according to claim 8, wherein the ethylenically unsaturated monomer is styrene, acrylonitrile or a mixture thereof.

10. The process according to claim 9, wherein the ethylenically unsaturated monomer is a mixture of styrene and acrylonitrile, and wherein the styrene/acrylonitrile weight ratio is between 88:12 and 20:80.

11. The process according to claim 8, wherein the macroinitiator is added in a weight proportion between 2 to 5 wt %, based on the total weight of base polyol, monomer(s), macroinitiator, polymerization initiator and, optionally, chain transfer agent.

12. A dispersant obtainable in situ in the process for preparing a polymer polyol, said dispersant being obtained by reacting the macroinitiator of formula (I) as defined in claim 1, with at least one ethylenically unsaturated monomer, wherein the process for preparing the polymer polyol comprises free-radical polymerizing in a base polyol at least one ethylenically unsaturated monomer in the presence of a free-radical polymerization initiator, a macroinitiator as defined in claim 1, and optionally a chain transfer agent.

13. A polymer polyol obtainable by a process as defined in claim 8, said polymer polyol comprising up to 60 wt %, based on the total weight of the polymer polyol, of a polymer derived from at least one ethylenically unsaturated monomer, which polymer is dispersed in a base polyol and stabilized with a dispersant.

14. The polymer polyol according to claim 13, said polymer polyol comprising up to 60 wt %, based on the total weight of the polymer polyol, of a polymer derived from styrene (SM) and acrylonitrile (ACN) monomers in a weight ratio SM:ACN 3-6:1, which polymer is dispersed in a base polyol and stabilized with a dispersant.

15. The polymer polyol according to claim 14 having a relative viscosity lower than 20, wherein said relative viscosity is the ratio between the viscosity of the polymer polyol and the viscosity of the base polyol, and wherein the viscosity of the polymer polyol and the viscosity of the base polyol are determined following EN ISO 3219 guidelines, employing a Haake iQ viscotester using the spindle CC25DIN/Ti and at 25° C. and 25 s⁻¹.
